(19) United States
(12) Patent Application Publication
(10) Pub. No.: US 2025/0203511 A1
(43) Pub. Date: Jun. 19, 2025

(54) ENERGY HARVESTING ACTIVITY TIMEOUTS

(71) Applicant: QUALCOMM Incorporated, San Diego, CA (US)

(72) Inventors: Ahmed ELSHAFIE, San Diego, CA (US); Linhai HE, San Diego, CA (US); Huilin XU, Temecula, CA (US); Seyedkianoush HOSSEINI, San Diego, CA (US); Yuchul KIM, San Diego, CA (US); Zhikun WU, Beijing (CN); Krishna Kiran MUKKAVILLI, San Diego, CA (US); Jing LEI, San Diego, CA (US)

(21) Appl. No.: 18/849,762

(22) PCT Filed: May 16, 2022
(86) PCT No.: PCT/CN2022/092932

§ 371 Date: Sep. 23, 2024

(51) Int. Cl. H04W 52/02; H02J 50/00; H04W 74/0833

(52) U.S. Cl. CPC H04W 52/0216; H02J 50/001; H04W 74/0833

(57) ABSTRACT

Methods, systems, and devices for wireless communications at a user equipment (UE) are described. The UE may transmit an indication of a time period for an energy harvesting procedure during which a first wireless device pauses communications with a second wireless device. The UE may pause a connected mode inactivity timer, a connected mode idle timer, or both, at the first wireless device at a beginning of the time period. The UE may perform the energy harvesting procedure during the time period. The UE may resume the connected mode inactivity timer, the connected mode idle timer, or both, at an end of the time period. The UE may communicate with the second wireless device in a connected communications mode after the end of the time period and in accordance with a status of the connected mode inactivity timer, the connected mode idle timer, or both.

### CROSS REFERENCE

The present Application is a 371 national phase filing of International PCT Application No. PCT/CN2022/092932 by ELSHAFIE et al., entitled “ENERGY HARVESTING ACTIVITY TIMEOUTS,” filed May 16, 2022, which is assigned to the assignee hereof, and which is expressly incorporated by reference in its entirety herein.

### TECHNICAL FIELD

The following relates to wireless communications, including energy harvesting activity timeouts.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications system, a wireless device may perform energy harvesting during which the wireless device may be unavailable for communications.

### SUMMARY

The described techniques relate to improved methods, systems, devices, and apparatuses that support energy harvesting activity timeouts. For example, a user equipment (UE) may transmit an indication of a time period for an energy harvesting procedure during which a first wireless device pauses communications with a second wireless device. The UE may pause a connected mode inactivity timer, a connected mode idle timer, or both, at the first wireless device at a beginning of the time period. The UE may perform the energy harvesting procedure during the time period. The UE may resume the connected mode inactivity timer, the connected mode idle timer, or both, at an end of the time period. The UE may communicate with the second wireless device in a connected communications mode after the end of the time period and in accordance with a status of the connected mode inactivity timer, the connected mode idle timer, or both.

A method for wireless communications is described. The method may include transmitting an indication of a time period for an energy harvesting procedure during which a first wireless device pauses communications with a second wireless device, pausing a connected mode inactivity timer, a connected mode idle timer, or both, at the first wireless device at a beginning of the time period, performing the energy harvesting procedure during the time period, resuming the connected mode inactivity timer, the connected mode idle timer, or both, at an end of the time period, and communicating with the second wireless device in a connected communications mode after the end of the time period and in accordance with a status of the connected mode inactivity timer, the connected mode idle timer, or both.

An apparatus for wireless communications is described. The apparatus may include a processor, memory coupled with the processor, and instructions stored in the memory. The instructions may be executable by the processor to cause the apparatus to transmit an indication of a time period for an energy harvesting procedure during which a first wireless device pauses communications with a second wireless device, pause a connected mode inactivity timer, a connected mode idle timer, or both, at the first wireless device at a beginning of the time period, perform the energy harvesting procedure during the time period, resume the connected mode inactivity timer, the connected mode idle timer, or both, at an end of the time period, and communicate with the second wireless device in a connected communications mode after the end of the time period and in accordance with a status of the connected mode inactivity timer, the connected mode idle timer, or both.

Another apparatus for wireless communications is described. The apparatus may include means for transmitting an indication of a time period for an energy harvesting procedure during which a first wireless device pauses communications with a second wireless device, means for pausing a connected mode inactivity timer, a connected mode idle timer, or both, at the first wireless device at a beginning of the time period, means for performing the energy harvesting procedure during the time period, means for resuming the connected mode inactivity timer, the connected mode idle timer, or both, at an end of the time period, and means for communicating with the second wireless device in a connected communications mode after the end of the time period and in accordance with a status of the connected mode inactivity timer, the connected mode idle timer, or both.

A non-transitory computer-readable medium storing code for wireless communications is described. The code may include instructions executable by a processor to transmit an indication of a time period for an energy harvesting procedure during which a first wireless device pauses communications with a second wireless device, pause a connected mode inactivity timer, a connected mode idle timer, or both, at the first wireless device at a beginning of the time period, perform the energy harvesting procedure during the time period, resume the connected mode inactivity timer, the connected mode idle timer, or both, at an end of the time period, and communicate with the second wireless device in a connected communications mode after the end of the time period and in accordance with a status of the connected mode inactivity timer, the connected mode idle timer, or both.

Some examples of the method, apparatuses, and non-transitory computer-readable medium described herein may further include operations, features, means, or instructions for receiving control signaling indicating that the first wireless device may be to communicate with the second wireless device during a second time period.

Some examples of the method, apparatuses, and non-transitory computer-readable medium described herein may further include operations, features, means, or instructions for receiving control signaling indicating that the first wireless device may be to perform a random access procedure over a set of random access resources indicated in the control signaling.

Some examples of the method, apparatuses, and non-transitory computer-readable medium described herein may further include operations, features, means, or instructions for performing the random access procedure over the set of random access resources with the second wireless device in accordance with the received control signaling.

Some examples of the method, apparatuses, and non-transitory computer-readable medium described herein may further include operations, features, means, or instructions for transmitting a random access preamble and an indication that the first wireless device will pause random access procedure communications.

Some examples of the method, apparatuses, and non-transitory computer-readable medium described herein may further include operations, features, means, or instructions for transmitting the indication of the time period including an indication that the first wireless device will not perform the random access procedure.

Some examples of the method, apparatuses, and non-transitory computer-readable medium described herein may further include operations, features, means, or instructions for transmitting an indication that the first wireless device may have resumed the connected mode inactivity timer, the connected mode idle timer, or both, based on resuming the connected mode inactivity timer, the connected mode idle timer, or both.

Some examples of the method, apparatuses, and non-transitory computer-readable medium described herein may further include operations, features, means, or instructions for starting a resumed communications timer and performing a random access procedure with the second wireless device according to an expiration of the resumed communications timer.

A method for wireless communications is described. The method may include receiving an indication of a time period for an energy harvesting procedure during which a first wireless device pauses communications with a second wireless device, pausing a connected mode inactivity timer, a connected mode idle timer, or both, at the second wireless device at a beginning of the time period, resuming the connected mode inactivity timer, the connected mode idle timer, or both, at an end of the time period, and communicating with the first wireless device in a connected communications mode after the end of the time period and in accordance with a status of the connected mode inactivity timer, the connected mode idle timer, or both.

An apparatus for wireless communications is described. The apparatus may include a processor, memory coupled with the processor, and instructions stored in the memory. The instructions may be executable by the processor to cause the apparatus to receive an indication of a time period for an energy harvesting procedure during which a first wireless device pauses communications with a second wireless device, pause a connected mode inactivity timer, a connected mode idle timer, or both, at the second wireless device at a beginning of the time period, resume the connected mode inactivity timer, the connected mode idle timer, or both, at an end of the time period, and communicate with the first wireless device in a connected communications mode after the end of the time period and in accordance with a status of the connected mode inactivity timer, the connected mode idle timer, or both.

Another apparatus for wireless communications is described. The apparatus may include means for receiving an indication of a time period for an energy harvesting procedure during which a first wireless device pauses communications with a second wireless device, means for pausing a connected mode inactivity timer, a connected mode idle timer, or both, at the second wireless device at a beginning of the time period, means for resuming the connected mode inactivity timer, the connected mode idle timer, or both, at an end of the time period, and means for communicating with the first wireless device in a connected communications mode after the end of the time period and in accordance with a status of the connected mode inactivity timer, the connected mode idle timer, or both.

A non-transitory computer-readable medium storing code for wireless communications is described. The code may include instructions executable by a processor to receive an indication of a time period for an energy harvesting procedure during which a first wireless device pauses communications with a second wireless device, pause a connected mode inactivity timer, a connected mode idle timer, or both, at the second wireless device at a beginning of the time period, resume the connected mode inactivity timer, the connected mode idle timer, or both, at an end of the time period, and communicate with the first wireless device in a connected communications mode after the end of the time period and in accordance with a status of the connected mode inactivity timer, the connected mode idle timer, or both.

Some examples of the method, apparatuses, and non-transitory computer-readable medium described herein may further include operations, features, means, or instructions for transmitting control signaling indicating that the first wireless device may be to communicate with the second wireless device during a second time period.

Some examples of the method, apparatuses, and non-transitory computer-readable medium described herein may further include operations, features, means, or instructions for transmitting control signaling indicating that the first wireless device may be to perform a random access procedure over a set of random access resources indicated in the control signaling.

Some examples of the method, apparatuses, and non-transitory computer-readable medium described herein may further include operations, features, means, or instructions for performing the random access procedure over the set of random access resources with the first wireless device in accordance with the transmitted control signaling.

Some examples of the method, apparatuses, and non-transitory computer-readable medium described herein may further include operations, features, means, or instructions for receiving a random access preamble and an indication that the first wireless device will pause random access procedure communications.

Some examples of the method, apparatuses, and non-transitory computer-readable medium described herein may further include operations, features, means, or instructions for receiving the indication of the time period including an indication that the first wireless device will not perform the random access procedure.

Some examples of the method, apparatuses, and non-transitory computer-readable medium described herein may further include operations, features, means, or instructions for receiving an indication that the first wireless device may have resumed the connected mode inactivity timer, the connected mode idle timer, or both, based on resuming the connected mode inactivity timer, the connected mode idle timer, or both.

Some examples of the method, apparatuses, and non-transitory computer-readable medium described herein may further include operations, features, means, or instructions for starting a resumed communications timer and performing a random access procedure with the first wireless device according to an expiration of the resumed communications timer.

A method for wireless communication is described. The method may include transmitting an indication of a time period for an energy harvesting procedure during which a first wireless device pauses communications with a second wireless device, selecting an initial value of a connected mode inactivity timer, a connected mode idle timer, or both, based on transmitting the indication of the time period, where the initial value is associated with the energy harvesting procedure, starting the connected mode inactivity timer, the connected mode idle timer, or both, at the first wireless device at a beginning of the time period according to the selected initial value, performing the energy harvesting procedure during the time period, and performing a random access procedure with the second wireless device according to an expiration of the connected mode inactivity timer, the connected mode idle timer, or both.

An apparatus for wireless communication is described. The apparatus may include a processor, memory coupled with the processor, and instructions stored in the memory. The instructions may be executable by the processor to cause the apparatus to transmit an indication of a time period for an energy harvesting procedure during which a first wireless device pauses communications with a second wireless device, select an initial value of a connected mode inactivity timer, a connected mode idle timer, or both, based on transmitting the indication of the time period, where the initial value is associated with the energy harvesting procedure, start the connected mode inactivity timer, the connected mode idle timer, or both, at the first wireless device at a beginning of the time period according to the selected initial value, perform the energy harvesting procedure during the time period, and perform a random access procedure with the second wireless device according to an expiration of the connected mode inactivity timer, the connected mode idle timer, or both.

Another apparatus for wireless communication is described. The apparatus may include means for transmitting an indication of a time period for an energy harvesting procedure during which a first wireless device pauses communications with a second wireless device, means for selecting an initial value of a connected mode inactivity timer, a connected mode idle timer, or both, based on transmitting the indication of the time period, where the initial value is associated with the energy harvesting procedure, means for starting the connected mode inactivity timer, the connected mode idle timer, or both, at the first wireless device at a beginning of the time period according to the selected initial value, means for performing the energy harvesting procedure during the time period, and means for performing a random access procedure with the second wireless device according to an expiration of the connected mode inactivity timer, the connected mode idle timer, or both.

A non-transitory computer-readable medium storing code for wireless communication is described. The code may include instructions executable by a processor to transmit an indication of a time period for an energy harvesting procedure during which a first wireless device pauses communications with a second wireless device, select an initial value of a connected mode inactivity timer, a connected mode idle timer, or both, based on transmitting the indication of the time period, where the initial value is associated with the energy harvesting procedure, start the connected mode inactivity timer, the connected mode idle timer, or both, at the first wireless device at a beginning of the time period according to the selected initial value, perform the energy harvesting procedure during the time period, and perform a random access procedure with the second wireless device according to an expiration of the connected mode inactivity timer, the connected mode idle timer, or both.

Some examples of the method, apparatuses, and non-transitory computer-readable medium described herein may further include operations, features, means, or instructions for determining that the first wireless device will enter an idle mode based on a length of the time period being greater than the initial value of the connected mode inactivity timer, the connected mode idle timer, or both.

Some examples of the method, apparatuses, and non-transitory computer-readable medium described herein may further include operations, features, means, or instructions for receiving an indication of random access resources and performing the random access procedure over the indicated random access resources.

Some examples of the method, apparatuses, and non-transitory computer-readable medium described herein may further include operations, features, means, or instructions for receiving control signaling including an indication of a time delay after an end of the time period for the energy harvesting procedure after which the random access procedure may be to be performed, an indication of the initial value of the connected mode inactivity timer, the connected mode idle timer, or both, or any combination thereof.

Some examples of the method, apparatuses, and non-transitory computer-readable medium described herein may further include operations, features, means, or instructions for transmitting an updated indication of the time period for the energy harvesting procedure.

Some examples of the method, apparatuses, and non-transitory computer-readable medium described herein may further include operations, features, means, or instructions for receiving control signaling including an indication of a timing advance associated with performing the random access procedure based on a length of the updated indication of the time period being longer than a threshold length.

Some examples of the method, apparatuses, and non-transitory computer-readable medium described herein may further include operations, features, means, or instructions for performing the random access procedure based on the received indication of the timing advance.

A method for wireless communication is described. The method may include receiving an indication of a time period for an energy harvesting procedure during which a first wireless device pauses communications with a second wireless device, selecting an initial value of a connected mode inactivity timer, a connected mode idle timer, or both, based on receiving the indication of the time period, where the initial value is associated with the energy harvesting procedure, starting the connected mode inactivity timer, the connected mode idle timer, or both, at the second wireless device at a beginning of the time period according to the selected initial value, and performing a random access procedure with the first wireless device according to an expiration of the connected mode inactivity timer, the connected mode idle timer, or both.

An apparatus for wireless communication is described. The apparatus may include a processor, memory coupled with the processor, and instructions stored in the memory. The instructions may be executable by the processor to cause the apparatus to receive an indication of a time period for an energy harvesting procedure during which a first wireless device pauses communications with a second wireless device, select an initial value of a connected mode inactivity timer, a connected mode idle timer, or both, based on receiving the indication of the time period, where the initial value is associated with the energy harvesting procedure, start the connected mode inactivity timer, the connected mode idle timer, or both, at the second wireless device at a beginning of the time period according to the selected initial value, and perform a random access procedure with the first wireless device according to an expiration of the connected mode inactivity timer, the connected mode idle timer, or both.

Another apparatus for wireless communication is described. The apparatus may include means for receiving an indication of a time period for an energy harvesting procedure during which a first wireless device pauses communications with a second wireless device, means for selecting an initial value of a connected mode inactivity timer, a connected mode idle timer, or both, based on receiving the indication of the time period, where the initial value is associated with the energy harvesting procedure, means for starting the connected mode inactivity timer, the connected mode idle timer, or both, at the second wireless device at a beginning of the time period according to the selected initial value, and means for performing a random access procedure with the first wireless device according to an expiration of the connected mode inactivity timer, the connected mode idle timer, or both.

A non-transitory computer-readable medium storing code for wireless communication is described. The code may include instructions executable by a processor to receive an indication of a time period for an energy harvesting procedure during which a first wireless device pauses communications with a second wireless device, select an initial value of a connected mode inactivity timer, a connected mode idle timer, or both, based on receiving the indication of the time period, where the initial value is associated with the energy harvesting procedure, start the connected mode inactivity timer, the connected mode idle timer, or both, at the second wireless device at a beginning of the time period according to the selected initial value, and perform a random access procedure with the first wireless device according to an expiration of the connected mode inactivity timer, the connected mode idle timer, or both.

Some examples of the method, apparatuses, and non-transitory computer-readable medium described herein may further include operations, features, means, or instructions for determining that the first wireless device will enter an idle mode based on a length of the time period being greater than the initial value of the connected mode inactivity timer, the connected mode idle timer, or both.

Some examples of the method, apparatuses, and non-transitory computer-readable medium described herein may further include operations, features, means, or instructions for transmitting an indication of random access resources and performing the random access procedure over the indicated random access resources.

Some examples of the method, apparatuses, and non-transitory computer-readable medium described herein may further include operations, features, means, or instructions for transmitting control signaling including an indication of a time delay after an end of the time period for the energy harvesting procedure after which the random access procedure may be to be performed, an indication of the initial value of the connected mode inactivity timer, the connected mode idle timer, or both, or any combination thereof.

Some examples of the method, apparatuses, and non-transitory computer-readable medium described herein may further include operations, features, means, or instructions for receiving an updated indication of the time period for the energy harvesting procedure.

Some examples of the method, apparatuses, and non-transitory computer-readable medium described herein may further include operations, features, means, or instructions for transmitting control signaling including an indication of a timing advance associated with performing the random access procedure based on a length of the updated indication of the time period being longer than a threshold length.

Some examples of the method, apparatuses, and non-transitory computer-readable medium described herein may further include operations, features, means, or instructions for performing the random access procedure based on the transmitted indication of the timing advance.

### BRIEF DESCRIPTION OF THE DRAWINGS

FIG. 1 illustrates an example of a wireless communications system that supports energy harvesting activity timeouts in accordance with one or more aspects of the present disclosure.

FIG. 2 illustrates an example of a timeout scheme that supports energy harvesting activity timeouts in accordance with one or more aspects of the present disclosure.

FIG. 3 illustrates an example of a timeout scheme that supports energy harvesting activity timeouts in accordance with one or more aspects of the present disclosure.

FIG. 4 illustrates an example of a process flow that supports energy harvesting activity timeouts in accordance with one or more aspects of the present disclosure.

FIG. 5 illustrates an example of a process flow that supports energy harvesting activity timeouts in accordance with one or more aspects of the present disclosure.

FIGS. 6 and 7 show block diagrams of devices that support energy harvesting activity timeouts in accordance with one or more aspects of the present disclosure.

FIG. 8 shows a block diagram of a communications manager that supports energy harvesting activity timeouts in accordance with one or more aspects of the present disclosure.

FIG. 9 shows a diagram of a system including a device that supports energy harvesting activity timeouts in accordance with one or more aspects of the present disclosure.

FIGS. 10 and 11 show block diagrams of devices that support energy harvesting activity timeouts in accordance with one or more aspects of the present disclosure.

FIG. 12 shows a block diagram of a communications manager that supports energy harvesting activity timeouts in accordance with one or more aspects of the present disclosure.

FIG. 13 shows a diagram of a system including a device that supports energy harvesting activity timeouts in accordance with one or more aspects of the present disclosure.

FIGS. 14 through 17 show flowcharts illustrating methods that support energy harvesting activity timeouts in accordance with one or more aspects of the present disclosure.

### DETAILED DESCRIPTION

Some wireless devices, such as passive user equipment (UEs), may engage in energy harvesting (EH) procedures or processes to harvest energy for operation from various sources (e.g., thermal sources, vibration sources, motion sources, radio frequency (RF) sources, other sources, or any combination thereof). If such a device does not have enough energy for communications or other operations, the device may engage in an EH procedure to accumulate energy for communications or other operations. Until such energy is accumulated, the device may not be reachable from the network. EH availability and rates may be somewhat unpredictable in nature and communication quality may also be unpredictable or intermittent as a result. In addition, a device performing EH procedures may fall into an inactivity or idle mode due to the lack of communication during the EH procedures and may engage in random access procedures to reestablish communications, consuming extra power.

To reduce or eliminate such issues, a wireless device may indicate that an amount of time for performing an EH procedure and, optionally, that the device may be unavailable for communications during such a time. In some examples, such a device (and possibly other devices, e.g., at a network) may maintain a connected mode (e.g., an RRC connected mode) for the wireless device during the EH procedures. For example, an inactivity timer may be paused while the device performs the EH procedures, and the timer may be resumed once the device returns to communications. In some examples, inactivity timers may be adjusted for EH devices. For example, inactivity timers for EH devices may use a larger initial value, thereby offering more time before the timer expires and the device enters an idle or inactive mode. In some examples, a device that enters an idle or inactive mode may perform a random access procedure to reestablish communications and such a procedure may be performed on dedicated random access resources to avoid collision or excess power expenditure. Additionally, or alternatively, such a procedure may be modified or abbreviated (e.g., by sending one message of a multi-message random access procedure) to avoid the use of excess power.

Aspects of the disclosure are initially described in the context of wireless communications systems. Aspects of the disclosure are then described in the context of energy harvesting timeout schemes and process flows. Aspects of the disclosure are further illustrated by and described with reference to apparatus diagrams, system diagrams, and flowcharts that relate to energy harvesting activity timeouts.

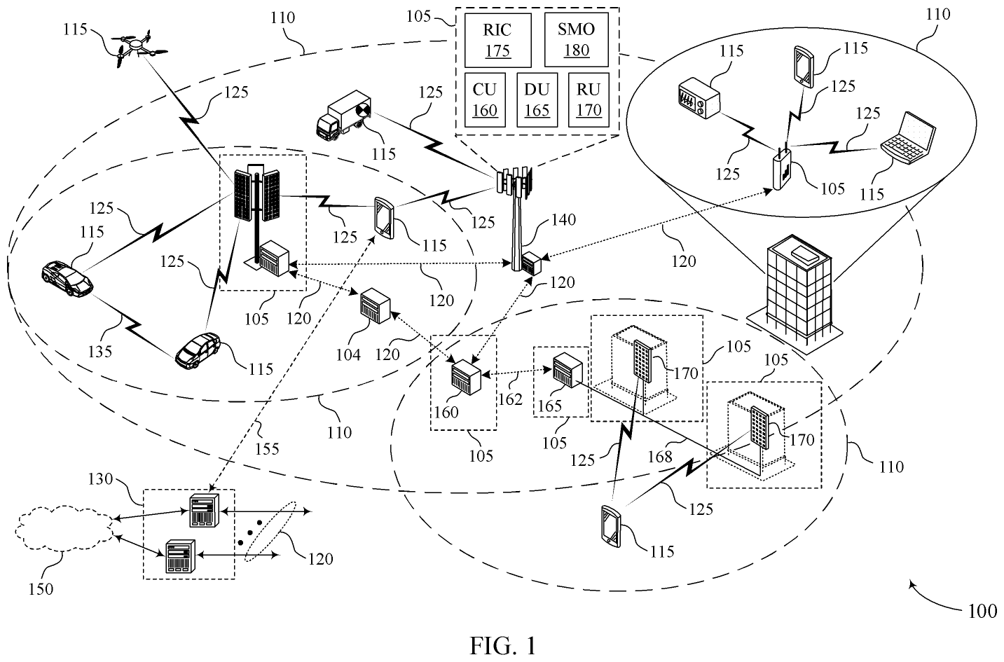

FIG. 1 illustrates an example of a wireless communications system 100 that supports energy harvesting activity timeouts in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support energy harvesting activity timeouts as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some implementations, a UE 115 and a network entity 105 may support one or more mechanisms according to which the UE 115 and the network entity 105 may manage time periods during which the UE 115 may be unavailable for communications during an EH procedure. For example, the UE 115 may transmit an indication (e.g., to the network entity 105) that the UE 115 may be performing an EH procedure for a period of time and may be unavailable for such a period of time. During such an EH procedure, the UE 115 may remain in a connected mode (e.g., an RRC connected mode) as a timer (e.g., an inactivity timer, an idle timer, another timer, or any combination thereof) may be paused for part or all of the time period for the EH procedure. The UE 115 may finish the EH procedure and may resume communications (e.g., with the network entity 105), and the one or more timers (e.g., the inactivity timer, the idle timer, another timer, or any combination thereof) may be resumed. In some examples, a threshold or value for one or more timers associated with the UE 115, an EH procedure, or both, may be selected. In some examples, such a selected threshold may be different (e.g., lower or higher) than another threshold or value used for non-EH devices. The UE 115 may finish the EH procedure and resume communications (e.g., with the network entity 105). In some examples, the UE 115 may perform a RACH process to resume communications, and the RACH process may be a modified process to avoid collision, reduce power consumption, or both.

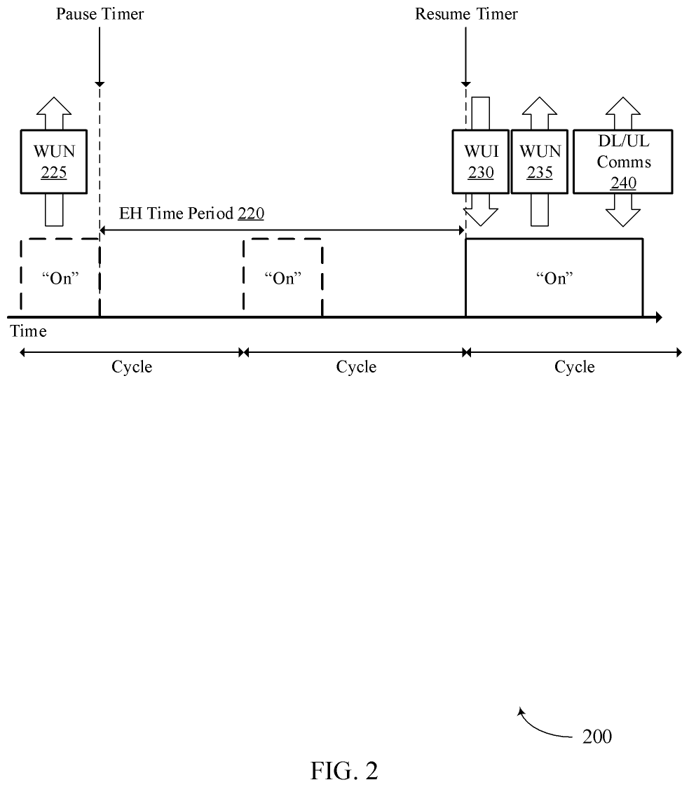

FIG. 2 illustrates an example of a timeout scheme 200 that supports energy harvesting activity timeouts in accordance with one or more aspects of the present disclosure.

Some wireless devices may engage in EH procedures or processes to harvest energy for operation from various sources. For example, a device may collect or convert energy (e.g., using one or more repurposed or dedicated sensors, modules, components, or any combination thereof) from one or more sources of ambient environmental energy, such as solar sources, thermal sources, vibration sources, light sources, RF sources, magnetic sources, airflow sources, other energy sources, or any combination thereof, and may convert such energy into direct current (DC) electricity for use or storage by the device. In the case of a UE, for example, a UE may use the collected energy to operate a modem or other elements of the UE (e.g., to perform one or more communications procedures).

However, if such accumulated energy is not sufficient to engage in communications, the wireless device may not perform the communications and may be unavailable for communications until enough energy is accumulated. In some examples, since energy harvesting availability and rates may be somewhat unpredictable in nature, communication quality between EH wireless device and network could be also unpredictable, intermittent, or suffer other effects.

For example, a wireless device that performs EH may operate in a duty cycled mode to save power. Such a duty cycled mode may include an “on” duration during which the wireless device may communicate with other devices, and an “off” duration (e.g., during which the wireless device may not communicate with other devices to save power). In some examples, such approaches may be described or defined as a discontinuous reception (DRX) mode. In such situations, the wireless device may not be available for communications at times. For example, communications attempted (e.g., a transmission from a network entity) may be lost if the communications occur while the wireless device is in an “off” state. Further, in some examples, a wireless device may not “wake up” or be active during an “on” duration due to low energy availability, even when the wireless device may have otherwise engaged in communications.

In some examples, a UE may indicate that the UE may be perform an EH procedure during the EH time period 220, during which time the UE may be unavailable for communications. The EH time period 220 may be described in terms of a number or quantity of time units, seconds, slots, or other time measurements. However, in some examples, the UE, a network entity, one or more other wireless devices, or any combination thereof, may employ the use of timers (e.g., inactivity timers, idle timers, one or more other timers, or any combination thereof). Such timers may be used to determine or select when a wireless device may transition between different modes of operation (e.g., a connected mode, an inactive mode, an idle mode, or another mode). In some cases, since the UE is engaging in an EH procedure, the duration of the EH procedure or EH time period 220 may be longer than a time period or amount of a timer, and the UE may leave a connected mode and may enter an inactive or idle mode. Such determination, selection, or transition between modes may be performed by the UE itself, a network entity, another wireless device, or any combination thereof). In some cases, upon finishing the EH procedure, the UE may be in a different mode than it was before the EH procedure and may perform a random access procedure to enter into connected mode once again (e.g., to communicate with a network entity or other wireless device). However, performing a random access procedure may be power consuming, and may use excessive amounts of power (e.g., particularly with an EH UE that may rely on EH to obtain power for communications operations).

Therefore (e.g., to reduce power consumption at the UE), the UE may stay in a connected mode (or other mode) during the EH time period 220. Upon finishing the EH procedure or expiration of the EH time period 220, the UE may still be in a connected mode, even though a timer for another device may have expired in the same amount of time.

For example, the UE may transmit a wake-up notification (WUN) or wake-up announcement (alternatively, wake-up acknowledgement) (WUA), such as WUN 225 that may notify or indicate to a network entity that the UE may pause communications with the network entity during a period of time (e.g., the EH time period 220). In some examples, the UE and the network entity (or other pairs of devices performing aspects of the subject matter described herein) may coordinate, determine, select, or otherwise obtain a time at which the UE and the network entity may pause one or more timers (e.g., an inactivity timer, an idle timer, or both). Such a time may be a last symbol of the WUN 225, a first symbol of the WUN 225, or any other symbol of the WUN 225. Additionally, or alternatively, the coordinated time may be a time that occurs a number of seconds, symbols, or slots (or other measurement or unit) after transmitting the WUN 225 or before transmitting the WUN 225. Such coordination of such a start time may be coordinated through control signaling or other signaling between wireless devices. In some examples, a start time may be configured by a network (e.g., L1/L2/L3 configured) or may be preconfigured or otherwise made available to wireless devices.

The UE may perform the EH procedure or procedures during the EH time period 220, during which time the UE may be unavailable for communications (even though the UE would otherwise enter into an “on” period as depicted in the figure). The UE may finish the EH procedure and the UE, the network entity, one or more other wireless devices, or any combination thereof may resume the one or more timers that were paused in connection with the WUN 225, the EH time period 220, or both. Such resumption of the timers may be coordinated between devices (e.g., as described herein in connection with coordinating the start time for pausing the one or more timers) or the various devices involved may resume the one or more timers based on the EH time period 220 expiring.

The UE may receive a wake-up indication, such as the WUI 230 (e.g., from the network entity) that may indicate to the UE to wake up to perform downlink (DL) or uplink (UL) communications, such as the DL/UL comms 240 (e.g., which may include downlink communications, uplink communications, or both). The UE may transmit the WUN 235 to indicate to the network entity that the UE may wake up to perform the DL/UL comms 240. The UE and the network entity may then engage in the DL/UL comms 240. In some examples, such communications may be based on or associated with a status of the one or more timers. For example, if one or more of the timers has not expired or reached, exceeded, or did not exceed a threshold associated with the timer, the UE and the network entity may engage in communications.

In some examples, an UL timing synchronization may be lost or may no longer be valid, or a timing alignment timer may expire. In some examples, if a WUN is sent before a WUI, the WUI may include (e.g., in a PDCCH transmission or message) an order or indication (e.g., a network order or indication) for the UE to perform a random access procedure, optionally on one or more random access procedure resources provided by the network entity or other wireless device. In some examples, if a WUI is transmitted before a WUN, such an order or indication may be transmitted in or in association with another (e.g., later) WUI. Additionally, or alternatively, control signaling (e.g., DCI) may be transmitting during an “on” time period. In some examples, a PDCCH order may be either contention free (e.g., on dedicated a resource) or may be contention-based (e.g., a 2-step RACH procedure or a 4-step RACH procedure, optionally performed over one or more common resources, such as physical random access channel (PRACH) resources).

In some examples, the UE may perform the random access procedure or may transmit an indication that the UE may not perform the random access procedure in a WUN (e.g., if a WUN follows a WUI).

In some examples, if UL timing synchronization is lost, is no longer valid, or a timing alignment timer expires, the UE may transmit one or more messages of a random access procedure, such as a Msg1 of a RACH procedure. Such a message may be transmitted based on whether the UE has sufficient energy to send one or more uplink transmissions (e.g., PUSCH transmissions). In some such cases, the UE may recover UL timing synchronization. In some examples, the UE may indicate whether it has enough power to continue communicating (e.g., transmitting or receiving) as part of the random access procedure. For example, the UE may transmit a WUN in or in connection with a Msg3 of a RACH procedure.

In some examples, a UE may transmit an indication that the UE has restarted one or more timers (e.g., once the UE has harvested an amount of energy). In some examples, the UE may obtain, select, or determine to use another timer (e.g., a configured timer). In some examples, if a network entity did not send an order (e.g., an order or indication to perform a random access procedure) and a timer (e.g., an inactivity or idle timer) expires, the UE may perform a random access procedure (e.g., a random access procedure as described herein that accommodates power considerations or another random access procedure that may not involve such power considerations).

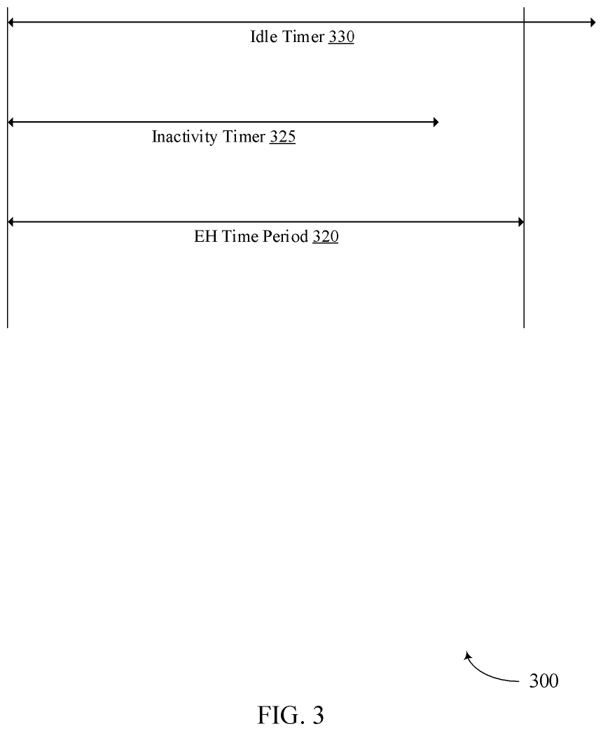

FIG. 3 illustrates an example of a timeout scheme 300 that supports energy harvesting activity timeouts in accordance with one or more aspects of the present disclosure.

As described herein, a UE may enter into an EH time period, such as EH time period 320, for EH procedures during which the UE may be unavailable for communications with one or more other wireless devices. In some examples, if a length of the 320//is longer, greater, or larger than a threshold associated with EH devices, a network entity may select or determine that the UE has entered an inactivity mode, an idle mode, or both (either at the same time or at different times in any order). In some examples, such thresholds may be larger than other timers used for other wireless devices (e.g., non-EH wireless devices). For example, one or more classes of EH devices may be defined or selected based on one or more charging rates, one or more technologies used for EH procedures, other characteristics, qualities, or capabilities of a wireless device, or any combination thereof. In some examples, a threshold for a timer may be based on a class into which a wireless device may fall. Additionally, or alternatively, such thresholds may be preconfigured or may be configured (e.g., by the network entity or another wireless device through signaling, such as control signaling (e.g., DCI, MAC-CE, RRC, or other control signaling)).

In some examples, one or more wireless devices may use one or more timers, such as the inactivity timer 325, the idle timer 330, or any combination thereof. In some examples, if the EH time period 320 is larger, longer, or of a greater value than the inactivity timer 325, then a UE performing EH procedures during the EH time period 320 may perform a random access procedure at the end of or after the time period 320. In some examples, the UE may perform a random access procedure as “normal” (e.g., without additional random access procedure considerations described herein) or may perform a random access procedure on dedicated resources (e.g., signaled by or associated with a network entity) to avoid collisions with other transmissions and wasting power of the UE. In some examples, a network entity may signal to the UE to use the “normal” random access procedure or may perform the random access procedure on dedicated resources (e.g., signaled by or associated with a network entity). In some examples, approaches described in relation to the inactivity timer 325 may be applied similarly in relation to the idle timer 330. For example, if the EH time period 320 is longer than the idle timer 330, the UE may perform a random access procedure as described herein.

In some examples, (e.g., at a time indicated by the UE, such as a time for a random access procedure), the network entity may assign one or more resources (e.g., dedicated resources) at a number or quantity of occasions for a random access procedure (e.g., a RACH procedure involving one or more of Msg1, Msg2, Msg3, or Msg4) that may be a contention-free random access procedure. In some examples, such a contention-free random access procedure may be performed if a “normal” or contention-based random access procedure fails. Resources used for a contention-free random access procedure may be configured (e.g., by the network entity) to be used at a point in time x+δ, where x may be the EH time period 320 (e.g., a length of the EH time period 320, an end of the EH time period 320 or other reference point of or associated with the EH time period 320) and δ may be a time period or a time offset, relative to x. In some examples, δ may be configured via control signaling (e.g., DCI, MAC-CE, or RRC). In some examples, one or more thresholds, values, or lengths for the inactivity timer 325, the idle timer 330, or both, may be configured via control signaling (e.g., DCI, MAC-CE, or RRC).

In some examples, the UE may indicate an updated value of x or the EH time period 320 at one or more times, such as when transmitting a WUN or over dedicated resources (e.g., a dedicated time) for updating the value of x or the EH time period 320.

In some examples, an updated value of x or the EH time period 320 may overwrites or take precedence over a previous value. In some examples, a network entity may adjust a timing advance (TA) for the UE (e.g., according to the new transmission or indication of the new value) and may do so if the new value is higher than a threshold defined, determined, selected, or obtained by the network entity. In some examples, the network entity may transmit an updated TA to the UE. In some examples, one or more previously-designated or allocated resources for the random access procedure may be canceled and the network entity may reallocate such resources (e.g., because the UE may not be able to use those resources due to a lack of energy or power).

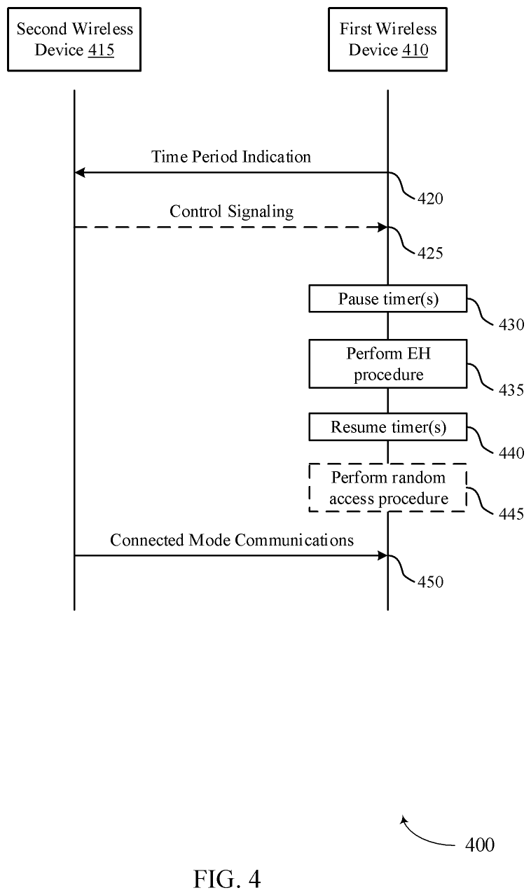

FIG. 4 illustrates an example of a process flow 400 that supports energy harvesting activity timeouts in accordance with one or more aspects of the present disclosure. The process flow 400 may implement various aspects of the present disclosure described herein. The elements described in the process flow 400 may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the first wireless device 410 may transmit an indication of a time period for an energy harvesting procedure during which a first wireless device pauses communications with a second wireless device 415. In some examples, the first wireless device 410 may transmit the indication of the time period including an indication that the first wireless device will not perform the random access procedure.

At 425, the first wireless device 410 may receive control signaling. The control signaling may indicate that the first wireless device is to communicate with the second wireless device 415 during a second time period. Additionally, or alternatively, the control signaling may indicate that the first wireless device is to perform a random access procedure over a set of random access resources indicated in the control signaling.

At 430, the first wireless device 410 may pause a connected mode inactivity timer, a connected mode idle timer, or both, at the first wireless device at a beginning of the time period.

At 435, the first wireless device 410 may perform the energy harvesting procedure during the time period.

At 440, the first wireless device 410 may resume the connected mode inactivity timer, the connected mode idle timer, or both, at an end of the time period. In some examples, the first wireless device 410 may transmit an indication that the first wireless device has resumed the connected mode inactivity timer, the connected mode idle timer, or both, based on resuming the connected mode inactivity timer, the connected mode idle timer, or both. In some examples, the first wireless device 410 may start a resumed communications timer.

At 445, the first wireless device 410 may perform the random access procedure over the set of random access resources with the second wireless device 415 in accordance with the received control signaling. In some examples, the first wireless device 410 may transmit a random access preamble and an indication that the first wireless device will pause random access procedure communications. In some examples, the first wireless device 410 may perform the random access procedure with the second wireless device 415 according to an expiration of the resumed communications timer.

At 450, the first wireless device 410 may communicate with the second wireless device 415 in a connected communications mode after the end of the time period and in accordance with a status of the connected mode inactivity timer, the connected mode idle timer, or both.

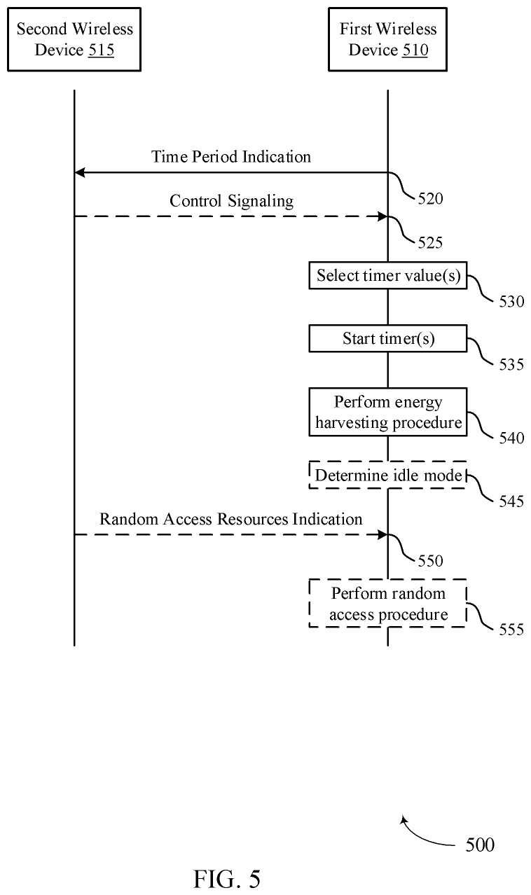

FIG. 5 illustrates an example of a process flow 500 that supports energy harvesting activity timeouts in accordance with one or more aspects of the present disclosure. The process flow 500 may implement various aspects of the present disclosure described herein. The elements described in the process flow 500 may be examples of similarly named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the first wireless device 510 may transmit an indication of a time period for an energy harvesting procedure during which a first wireless device pauses communications with a second wireless device 515. In some examples, the first wireless device 510 may transmit an updated indication of the time period for the energy harvesting procedure.

At 525, the first wireless device 510 may receive control signaling comprising an indication of a time delay after an end of the time period for the energy harvesting procedure after which the random access procedure is to be performed, an indication of the initial value of the connected mode inactivity timer, the connected mode idle timer, or both, or any combination thereof. Additionally, or alternatively, the first wireless device 510 may receive control signaling including an indication of a timing advance associated with performing the random access procedure based on a length of the updated indication of the time period being longer than a threshold length.

At 530, the first wireless device 510 may select an initial value of a connected mode inactivity timer, a connected mode idle timer, or both, based on transmitting the indication of the time period, wherein the initial value is associated with the energy harvesting procedure.

At 535, the first wireless device 510 may start the connected mode inactivity timer, the connected mode idle timer, or both, at the first wireless device at a beginning of the time period according to the selected initial value.

At 540, the first wireless device 510 may perform the energy harvesting procedure during the time period.

At 545, the first wireless device 510 may determine that the first wireless device may enter or will enter an idle mode based on a length of the time period being greater than the initial value of the connected mode inactivity timer, the connected mode idle timer, or both.

At 550, the first wireless device 510 may receive an indication of random access resources. For example, the first wireless device 510 may monitor one or more synchronization signal blocks (SSBs) to ascertain, determine, or otherwise obtain a random access occasion for performing a random access procedure. The first wireless device 510 may further select one or more random access occasions for performing one or more elements of a random access procedure, such as transmitting a random access preamble message.

At 555, the first wireless device 510 may perform a random access procedure with the second wireless device 515 according to an expiration of the connected mode inactivity timer, the connected mode idle timer, or both. In some examples, the first wireless device 510 may perform the random access procedure over the indicated random access resources. In some examples, the first wireless device 510 may perform the random access procedure based on the received indication of the timing advance.

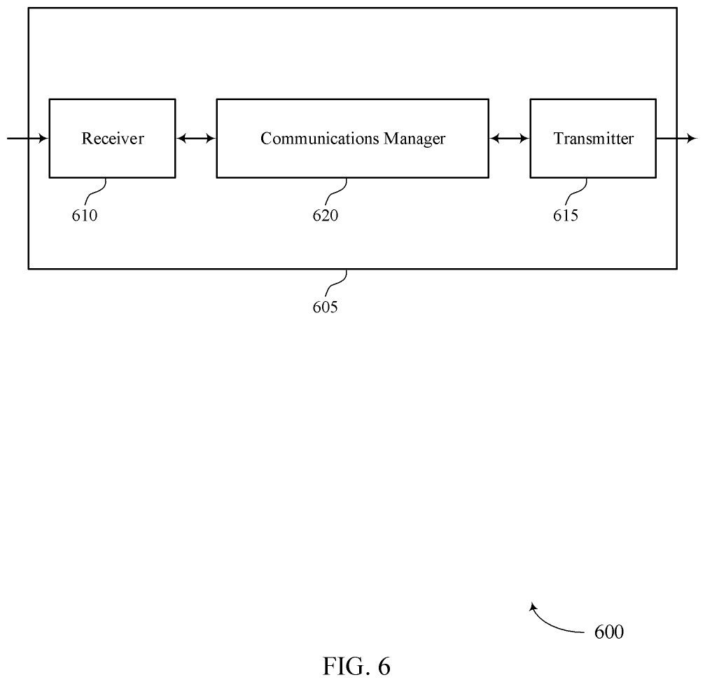

FIG. 6 shows a block diagram 600 of a device 605 that supports energy harvesting activity timeouts in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to energy harvesting activity timeouts). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to energy harvesting activity timeouts). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of energy harvesting activity timeouts as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 may be configured as or otherwise support a means for transmitting an indication of a time period for an energy harvesting procedure during which a first wireless device pauses communications with a second wireless device. The communications manager 620 may be configured as or otherwise support a means for pausing a connected mode inactivity timer, a connected mode idle timer, or both, at the first wireless device at a beginning of the time period. The communications manager 620 may be configured as or otherwise support a means for performing the energy harvesting procedure during the time period. The communications manager 620 may be configured as or otherwise support a means for resuming the connected mode inactivity timer, the connected mode idle timer, or both, at an end of the time period. The communications manager 620 may be configured as or otherwise support a means for communicating with the second wireless device in a connected communications mode after the end of the time period and in accordance with a status of the connected mode inactivity timer, the connected mode idle timer, or both.

Additionally, or alternatively, the communications manager 620 may support wireless communication in accordance with examples as disclosed herein. For example, the communications manager 620 may be configured as or otherwise support a means for transmitting an indication of a time period for an energy harvesting procedure during which a first wireless device pauses communications with a second wireless device. The communications manager 620 may be configured as or otherwise support a means for selecting an initial value of a connected mode inactivity timer, a connected mode idle timer, or both, based on transmitting the indication of the time period, where the initial value is associated with the energy harvesting procedure. The communications manager 620 may be configured as or otherwise support a means for starting the connected mode inactivity timer, the connected mode idle timer, or both, at the first wireless device at a beginning of the time period according to the selected initial value. The communications manager 620 may be configured as or otherwise support a means for performing the energy harvesting procedure during the time period. The communications manager 620 may be configured as or otherwise support a means for performing a random access procedure with the second wireless device according to an expiration of the connected mode inactivity timer, the connected mode idle timer, or both.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, more efficient utilization of communication resources, or any combination thereof.

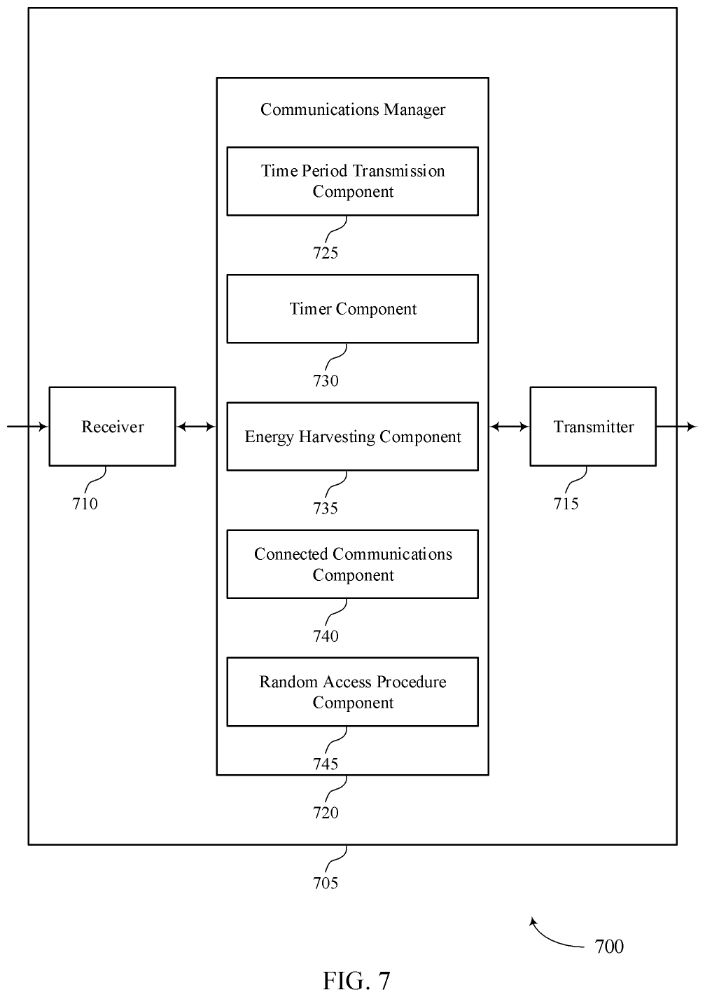

FIG. 7 shows a block diagram 700 of a device 705 that supports energy harvesting activity timeouts in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to energy harvesting activity timeouts). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to energy harvesting activity timeouts). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of energy harvesting activity timeouts as described herein. For example, the communications manager 720 may include a time period transmission component 725, a timer component 730, an energy harvesting component 735, a connected communications component 740, a random access procedure component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The time period transmission component 725 may be configured as or otherwise support a means for transmitting an indication of a time period for an energy harvesting procedure during which a first wireless device pauses communications with a second wireless device. The timer component 730 may be configured as or otherwise support a means for pausing a connected mode inactivity timer, a connected mode idle timer, or both, at the first wireless device at a beginning of the time period. The energy harvesting component 735 may be configured as or otherwise support a means for performing the energy harvesting procedure during the time period. The timer component 730 may be configured as or otherwise support a means for resuming the connected mode inactivity timer, the connected mode idle timer, or both, at an end of the time period. The connected communications component 740 may be configured as or otherwise support a means for communicating with the second wireless device in a connected communications mode after the end of the time period and in accordance with a status of the connected mode inactivity timer, the connected mode idle timer, or both.

Additionally, or alternatively, the communications manager 720 may support wireless communication in accordance with examples as disclosed herein. The time period transmission component 725 may be configured as or otherwise support a means for transmitting an indication of a time period for an energy harvesting procedure during which a first wireless device pauses communications with a second wireless device. The timer component 730 may be configured as or otherwise support a means for selecting an initial value of a connected mode inactivity timer, a connected mode idle timer, or both, based on transmitting the indication of the time period, where the initial value is associated with the energy harvesting procedure. The timer component 730 may be configured as or otherwise support a means for starting the connected mode inactivity timer, the connected mode idle timer, or both, at the first wireless device at a beginning of the time period according to the selected initial value. The energy harvesting component 735 may be configured as or otherwise support a means for performing the energy harvesting procedure during the time period. The random access procedure component 745 may be configured as or otherwise support a means for performing a random access procedure with the second wireless device according to an expiration of the connected mode inactivity timer, the connected mode idle timer, or both.

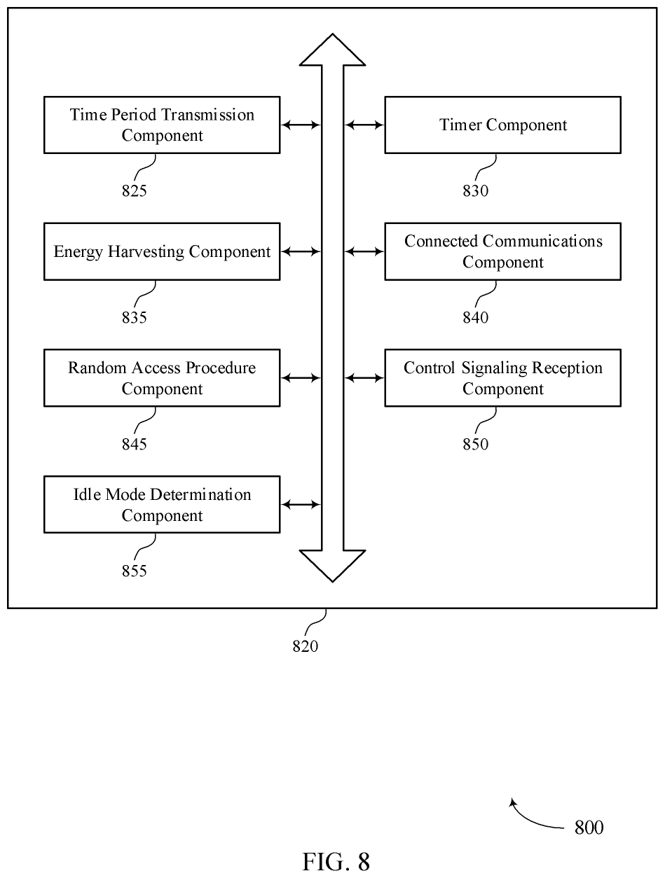

FIG. 8 shows a block diagram 800 of a communications manager 820 that supports energy harvesting activity timeouts in accordance with one or more aspects of the present disclosure. The communications manager 820 may be an example of aspects of a communications manager 620, a communications manager 720, or both, as described herein. The communications manager 820, or various components thereof, may be an example of means for performing various aspects of energy harvesting activity timeouts as described herein. For example, the communications manager 820 may include a time period transmission component 825, a timer component 830, an energy harvesting component 835, a connected communications component 840, a random access procedure component 845, a control signaling reception component 850, an idle mode determination component 855, or any combination thereof. Each of these components may communicate, directly or indirectly, with one another (e.g., via one or more buses).

The communications manager 820 may support wireless communications in accordance with examples as disclosed herein. The time period transmission component 825 may be configured as or otherwise support a means for transmitting an indication of a time period for an energy harvesting procedure during which a first wireless device pauses communications with a second wireless device. The timer component 830 may be configured as or otherwise support a means for pausing a connected mode inactivity timer, a connected mode idle timer, or both, at the first wireless device at a beginning of the time period. The energy harvesting component 835 may be configured as or otherwise support a means for performing the energy harvesting procedure during the time period. In some examples, the timer component 830 may be configured as or otherwise support a means for resuming the connected mode inactivity timer, the connected mode idle timer, or both, at an end of the time period. The connected communications component 840 may be configured as or otherwise support a means for communicating with the second wireless device in a connected communications mode after the end of the time period and in accordance with a status of the connected mode inactivity timer, the connected mode idle timer, or both.

In some examples, the control signaling reception component 850 may be configured as or otherwise support a means for receiving control signaling indicating that the first wireless device is to communicate with the second wireless device during a second time period.

In some examples, the control signaling reception component 850 may be configured as or otherwise support a means for receiving control signaling indicating that the first wireless device is to perform a random access procedure over a set of random access resources indicated in the control signaling.

In some examples, the random access procedure component 845 may be configured as or otherwise support a means for performing the random access procedure over the set of random access resources with the second wireless device in accordance with the received control signaling.

In some examples, the random access procedure component 845 may be configured as or otherwise support a means for transmitting a random access preamble and an indication that the first wireless device will pause random access procedure communications.

In some examples, the time period transmission component 825 may be configured as or otherwise support a means for transmitting the indication of the time period including an indication that the first wireless device will not perform the random access procedure.

In some examples, the timer component 830 may be configured as or otherwise support a means for transmitting an indication that the first wireless device has resumed the connected mode inactivity timer, the connected mode idle timer, or both, based on resuming the connected mode inactivity timer, the connected mode idle timer, or both.

In some examples, the timer component 830 may be configured as or otherwise support a means for starting a resumed communications timer. In some examples, the random access procedure component 845 may be configured as or otherwise support a means for performing a random access procedure with the second wireless device according to an expiration of the resumed communications timer.

Additionally, or alternatively, the communications manager 820 may support wireless communication in accordance with examples as disclosed herein. In some examples, the time period transmission component 825 may be configured as or otherwise support a means for transmitting an indication of a time period for an energy harvesting procedure during which a first wireless device pauses communications with a second wireless device. In some examples, the timer component 830 may be configured as or otherwise support a means for selecting an initial value of a connected mode inactivity timer, a connected mode idle timer, or both, based on transmitting the indication of the time period, where the initial value is associated with the energy harvesting procedure. In some examples, the timer component 830 may be configured as or otherwise support a means for starting the connected mode inactivity timer, the connected mode idle timer, or both, at the first wireless device at a beginning of the time period according to the selected initial value. In some examples, the energy harvesting component 835 may be configured as or otherwise support a means for performing the energy harvesting procedure during the time period. The random access procedure component 845 may be configured as or otherwise support a means for performing a random access procedure with the second wireless device according to an expiration of the connected mode inactivity timer, the connected mode idle timer, or both.

In some examples, the idle mode determination component 855 may be configured as or otherwise support a means for determining that the first wireless device will enter an idle mode based on a length of the time period being greater than the initial value of the connected mode inactivity timer, the connected mode idle timer, or both.

In some examples, the random access procedure component 845 may be configured as or otherwise support a means for receiving an indication of random access resources. In some examples, the random access procedure component 845 may be configured as or otherwise support a means for performing the random access procedure over the indicated random access resources.

In some examples, the control signaling reception component 850 may be configured as or otherwise support a means for receiving control signaling including an indication of a time delay after an end of the time period for the energy harvesting procedure after which the random access procedure is to be performed, an indication of the initial value of the connected mode inactivity timer, the connected mode idle timer, or both, or any combination thereof.

In some examples, the time period transmission component 825 may be configured as or otherwise support a means for transmitting an updated indication of the time period for the energy harvesting procedure.

In some examples, the control signaling reception component 850 may be configured as or otherwise support a means for receiving control signaling including an indication of a timing advance associated with performing the random access procedure based on a length of the updated indication of the time period being longer than a threshold length.

In some examples, the random access procedure component 845 may be configured as or otherwise support a means for performing the random access procedure based on the received indication of the timing advance.

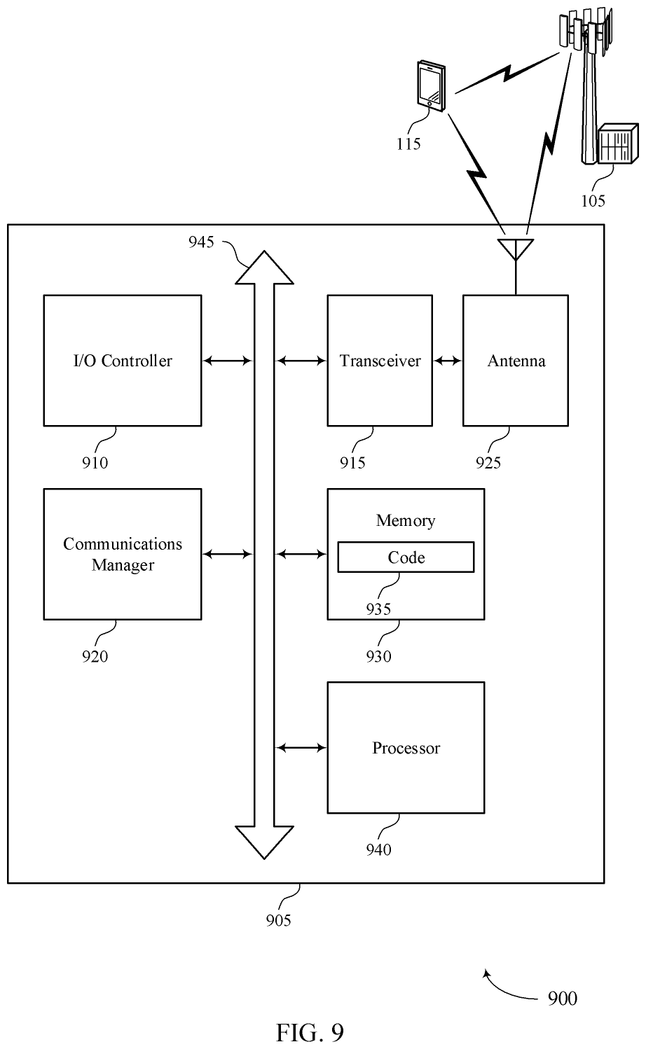

FIG. 9 shows a diagram of a system 900 including a device 905 that supports energy harvesting activity timeouts in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting energy harvesting activity timeouts). For example, the device 905 or a component of the device 905 may include a processor 940 and memory 930 coupled with or to the processor 940, the processor 940 and memory 930 configured to perform various functions described herein.

The communications manager 920 may support wireless communications in accordance with examples as disclosed herein. For example, the communications manager 920 may be configured as or otherwise support a means for transmitting an indication of a time period for an energy harvesting procedure during which a first wireless device pauses communications with a second wireless device. The communications manager 920 may be configured as or otherwise support a means for pausing a connected mode inactivity timer, a connected mode idle timer, or both, at the first wireless device at a beginning of the time period. The communications manager 920 may be configured as or otherwise support a means for performing the energy harvesting procedure during the time period. The communications manager 920 may be configured as or otherwise support a means for resuming the connected mode inactivity timer, the connected mode idle timer, or both, at an end of the time period. The communications manager 920 may be configured as or otherwise support a means for communicating with the second wireless device in a connected communications mode after the end of the time period and in accordance with a status of the connected mode inactivity timer, the connected mode idle timer, or both.

Additionally, or alternatively, the communications manager 920 may support wireless communication in accordance with examples as disclosed herein. For example, the communications manager 920 may be configured as or otherwise support a means for transmitting an indication of a time period for an energy harvesting procedure during which a first wireless device pauses communications with a second wireless device. The communications manager 920 may be configured as or otherwise support a means for selecting an initial value of a connected mode inactivity timer, a connected mode idle timer, or both, based on transmitting the indication of the time period, where the initial value is associated with the energy harvesting procedure. The communications manager 920 may be configured as or otherwise support a means for starting the connected mode inactivity timer, the connected mode idle timer, or both, at the first wireless device at a beginning of the time period according to the selected initial value. The communications manager 920 may be configured as or otherwise support a means for performing the energy harvesting procedure during the time period. The communications manager 920 may be configured as or otherwise support a means for performing a random access procedure with the second wireless device according to an expiration of the connected mode inactivity timer, the connected mode idle timer, or both.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of energy harvesting activity timeouts as described herein, or the processor 940 and the memory 930 may be otherwise configured to perform or support such operations.

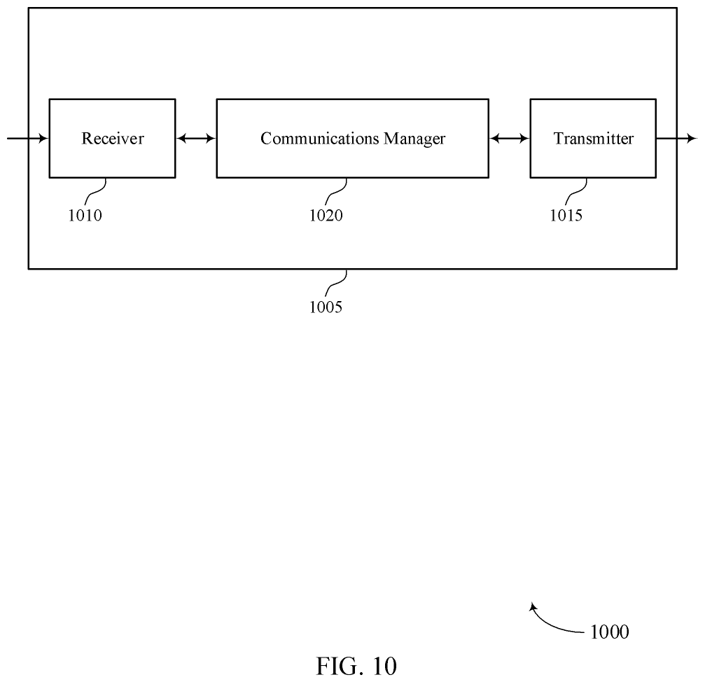

FIG. 10 shows a block diagram 1000 of a device 1005 that supports energy harvesting activity timeouts in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of energy harvesting activity timeouts as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 may be configured as or otherwise support a means for receiving an indication of a time period for an energy harvesting procedure during which a first wireless device pauses communications with a second wireless device. The communications manager 1020 may be configured as or otherwise support a means for pausing a connected mode inactivity timer, a connected mode idle timer, or both, at the second wireless device at a beginning of the time period. The communications manager 1020 may be configured as or otherwise support a means for resuming the connected mode inactivity timer, the connected mode idle timer, or both, at an end of the time period. The communications manager 1020 may be configured as or otherwise support a means for communicating with the first wireless device in a connected communications mode after the end of the time period and in accordance with a status of the connected mode inactivity timer, the connected mode idle timer, or both.

Additionally, or alternatively, the communications manager 1020 may support wireless communication in accordance with examples as disclosed herein. For example, the communications manager 1020 may be configured as or otherwise support a means for receiving an indication of a time period for an energy harvesting procedure during which a first wireless device pauses communications with a second wireless device. The communications manager 1020 may be configured as or otherwise support a means for selecting an initial value of a connected mode inactivity timer, a connected mode idle timer, or both, based on receiving the indication of the time period, where the initial value is associated with the energy harvesting procedure. The communications manager 1020 may be configured as or otherwise support a means for starting the connected mode inactivity timer, the connected mode idle timer, or both, at the second wireless device at a beginning of the time period according to the selected initial value. The communications manager 1020 may be configured as or otherwise support a means for performing a random access procedure with the first wireless device according to an expiration of the connected mode inactivity timer, the connected mode idle timer, or both.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, more efficient utilization of communication resources, or any combination thereof.

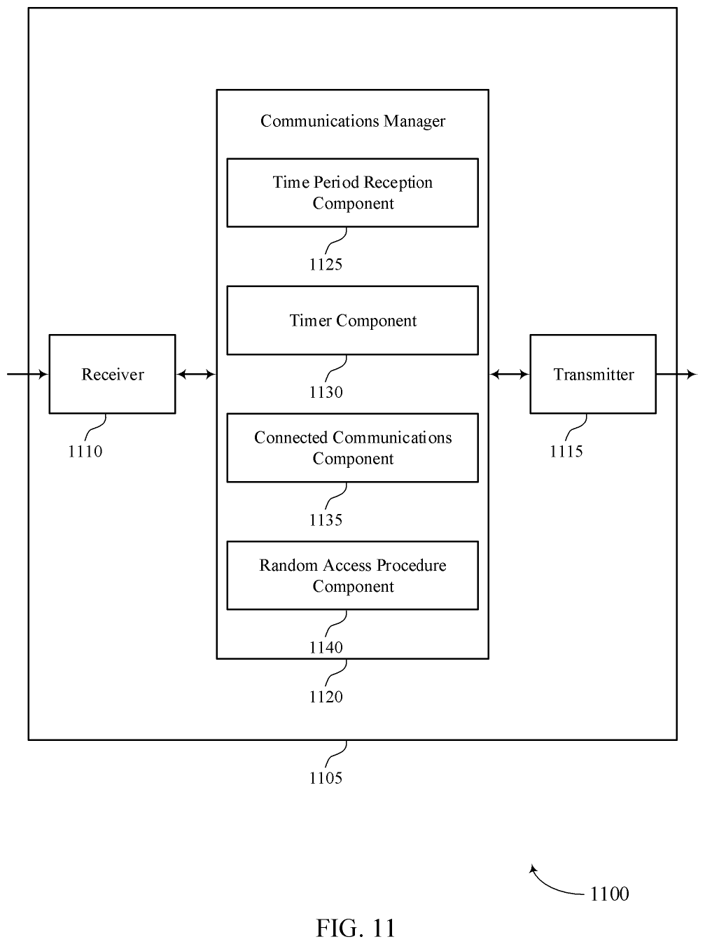

FIG. 11 shows a block diagram 1100 of a device 1105 that supports energy harvesting activity timeouts in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of energy harvesting activity timeouts as described herein. For example, the communications manager 1120 may include a time period reception component 1125, a timer component 1130, a connected communications component 1135, a random access procedure component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The time period reception component 1125 may be configured as or otherwise support a means for receiving an indication of a time period for an energy harvesting procedure during which a first wireless device pauses communications with a second wireless device. The timer component 1130 may be configured as or otherwise support a means for pausing a connected mode inactivity timer, a connected mode idle timer, or both, at the second wireless device at a beginning of the time period. The timer component 1130 may be configured as or otherwise support a means for resuming the connected mode inactivity timer, the connected mode idle timer, or both, at an end of the time period. The connected communications component 1135 may be configured as or otherwise support a means for communicating with the first wireless device in a connected communications mode after the end of the time period and in accordance with a status of the connected mode inactivity timer, the connected mode idle timer, or both.

Additionally, or alternatively, the communications manager 1120 may support wireless communication in accordance with examples as disclosed herein. The time period reception component 1125 may be configured as or otherwise support a means for receiving an indication of a time period for an energy harvesting procedure during which a first wireless device pauses communications with a second wireless device. The timer component 1130 may be configured as or otherwise support a means for selecting an initial value of a connected mode inactivity timer, a connected mode idle timer, or both, based on receiving the indication of the time period, where the initial value is associated with the energy harvesting procedure. The timer component 1130 may be configured as or otherwise support a means for starting the connected mode inactivity timer, the connected mode idle timer, or both, at the second wireless device at a beginning of the time period according to the selected initial value. The random access procedure component 1140 may be configured as or otherwise support a means for performing a random access procedure with the first wireless device according to an expiration of the connected mode inactivity timer, the connected mode idle timer, or both.

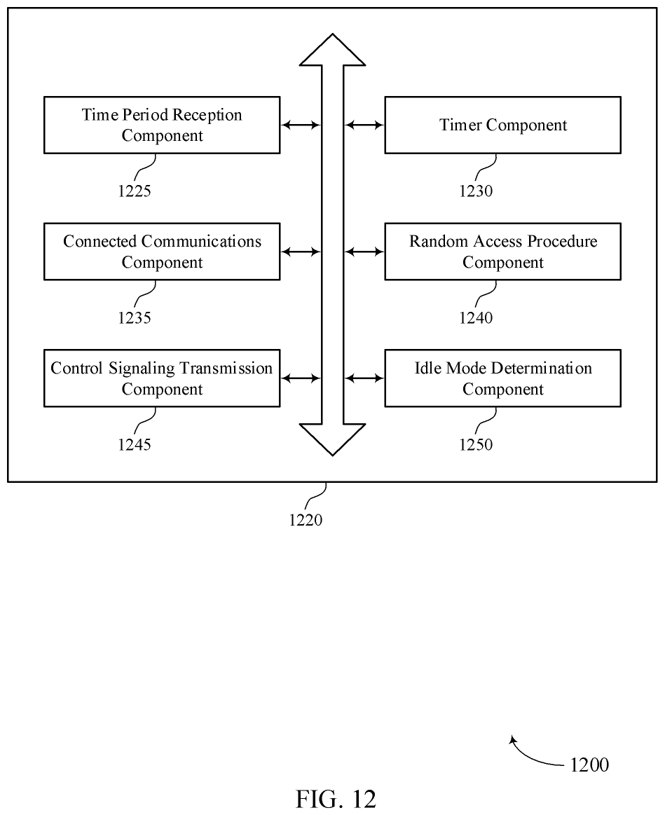

FIG. 12 shows a block diagram 1200 of a communications manager 1220

that supports energy harvesting activity timeouts in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of energy harvesting activity timeouts as described herein. For example, the communications manager 1220 may include a time period reception component 1225, a timer component 1230, a connected communications component 1235, a random access procedure component 1240, a control signaling transmission component 1245, an idle mode determination component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The time period reception component 1225 may be configured as or otherwise support a means for receiving an indication of a time period for an energy harvesting procedure during which a first wireless device pauses communications with a second wireless device. The timer component 1230 may be configured as or otherwise support a means for pausing a connected mode inactivity timer, a connected mode idle timer, or both, at the second wireless device at a beginning of the time period. In some examples, the timer component 1230 may be configured as or otherwise support a means for resuming the connected mode inactivity timer, the connected mode idle timer, or both, at an end of the time period. The connected communications component 1235 may be configured as or otherwise support a means for communicating with the first wireless device in a connected communications mode after the end of the time period and in accordance with a status of the connected mode inactivity timer, the connected mode idle timer, or both.

In some examples, the control signaling transmission component 1245 may be configured as or otherwise support a means for transmitting control signaling indicating that the first wireless device is to communicate with the second wireless device during a second time period.

In some examples, the control signaling transmission component 1245 may be configured as or otherwise support a means for transmitting control signaling indicating that the first wireless device is to perform a random access procedure over a set of random access resources indicated in the control signaling.

In some examples, the random access procedure component 1240 may be configured as or otherwise support a means for performing the random access procedure over the set of random access resources with the first wireless device in accordance with the transmitted control signaling.

In some examples, the random access procedure component 1240 may be configured as or otherwise support a means for receiving a random access preamble and an indication that the first wireless device will pause random access procedure communications.

In some examples, the time period reception component 1225 may be configured as or otherwise support a means for receiving the indication of the time period including an indication that the first wireless device will not perform the random access procedure.

In some examples, the timer component 1230 may be configured as or otherwise support a means for receiving an indication that the first wireless device has resumed the connected mode inactivity timer, the connected mode idle timer, or both, based on resuming the connected mode inactivity timer, the connected mode idle timer, or both.

In some examples, the timer component 1230 may be configured as or otherwise support a means for starting a resumed communications timer. In some examples, the random access procedure component 1240 may be configured as or otherwise support a means for performing a random access procedure with the first wireless device according to an expiration of the resumed communications timer.

Additionally, or alternatively, the communications manager 1220 may support wireless communication in accordance with examples as disclosed herein. In some examples, the time period reception component 1225 may be configured as or otherwise support a means for receiving an indication of a time period for an energy harvesting procedure during which a first wireless device pauses communications with a second wireless device. In some examples, the timer component 1230 may be configured as or otherwise support a means for selecting an initial value of a connected mode inactivity timer, a connected mode idle timer, or both, based on receiving the indication of the time period, where the initial value is associated with the energy harvesting procedure. In some examples, the timer component 1230 may be configured as or otherwise support a means for starting the connected mode inactivity timer, the connected mode idle timer, or both, at the second wireless device at a beginning of the time period according to the selected initial value. The random access procedure component 1240 may be configured as or otherwise support a means for performing a random access procedure with the first wireless device according to an expiration of the connected mode inactivity timer, the connected mode idle timer, or both.

In some examples, the idle mode determination component 1250 may be configured as or otherwise support a means for determining that the first wireless device will enter an idle mode based on a length of the time period being greater than the initial value of the connected mode inactivity timer, the connected mode idle timer, or both.

In some examples, the random access procedure component 1240 may be configured as or otherwise support a means for transmitting an indication of random access resources. In some examples, the random access procedure component 1240 may be configured as or otherwise support a means for performing the random access procedure over the indicated random access resources.

In some examples, the control signaling transmission component 1245 may be configured as or otherwise support a means for transmitting control signaling including an indication of a time delay after an end of the time period for the energy harvesting procedure after which the random access procedure is to be performed, an indication of the initial value of the connected mode inactivity timer, the connected mode idle timer, or both, or any combination thereof.

In some examples, the time period reception component 1225 may be configured as or otherwise support a means for receiving an updated indication of the time period for the energy harvesting procedure.

In some examples, the control signaling transmission component 1245 may be configured as or otherwise support a means for transmitting control signaling including an indication of a timing advance associated with performing the random access procedure based on a length of the updated indication of the time period being longer than a threshold length.

In some examples, the random access procedure component 1240 may be configured as or otherwise support a means for performing the random access procedure based on the transmitted indication of the timing advance.

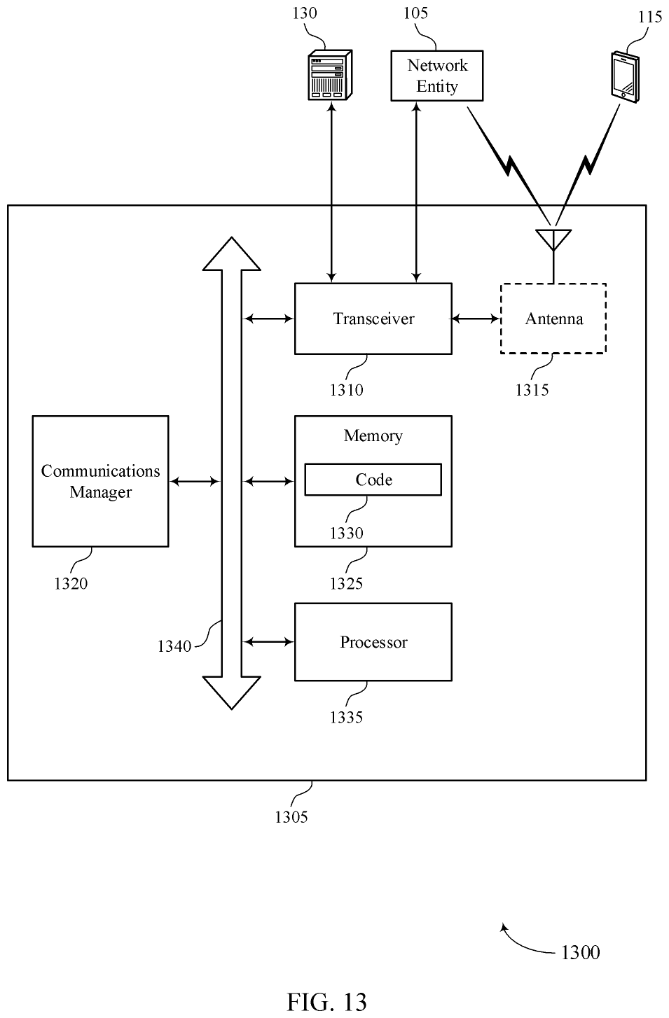

FIG. 13 shows a diagram of a system 1300 including a device 1305 that supports energy harvesting activity timeouts in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting energy harvesting activity timeouts). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 may be configured as or otherwise support a means for receiving an indication of a time period for an energy harvesting procedure during which a first wireless device pauses communications with a second wireless device. The communications manager 1320 may be configured as or otherwise support a means for pausing a connected mode inactivity timer, a connected mode idle timer, or both, at the second wireless device at a beginning of the time period. The communications manager 1320 may be configured as or otherwise support a means for resuming the connected mode inactivity timer, the connected mode idle timer, or both, at an end of the time period. The communications manager 1320 may be configured as or otherwise support a means for communicating with the first wireless device in a connected communications mode after the end of the time period and in accordance with a status of the connected mode inactivity timer, the connected mode idle timer, or both.

Additionally, or alternatively, the communications manager 1320 may support wireless communication in accordance with examples as disclosed herein. For example, the communications manager 1320 may be configured as or otherwise support a means for receiving an indication of a time period for an energy harvesting procedure during which a first wireless device pauses communications with a second wireless device. The communications manager 1320 may be configured as or otherwise support a means for selecting an initial value of a connected mode inactivity timer, a connected mode idle timer, or both, based on receiving the indication of the time period, where the initial value is associated with the energy harvesting procedure. The communications manager 1320 may be configured as or otherwise support a means for starting the connected mode inactivity timer, the connected mode idle timer, or both, at the second wireless device at a beginning of the time period according to the selected initial value. The communications manager 1320 may be configured as or otherwise support a means for performing a random access procedure with the first wireless device according to an expiration of the connected mode inactivity timer, the connected mode idle timer, or both.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of energy harvesting activity timeouts as described herein, or the processor 1335 and the memory 1325 may be otherwise configured to perform or support such operations.

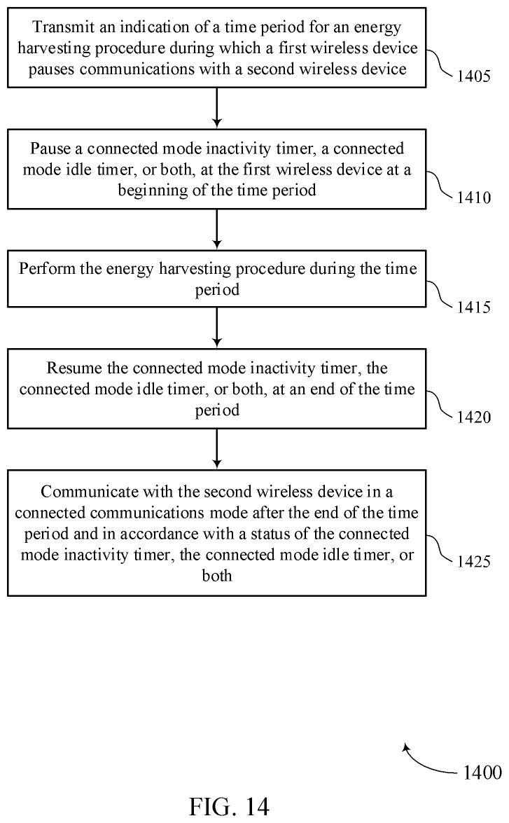

FIG. 14 shows a flowchart illustrating a method 1400 that supports energy harvesting activity timeouts in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting an indication of a time period for an energy harvesting procedure during which a first wireless device pauses communications with a second wireless device. The operations of 1405 may be performed in accordance with examples as disclosed herein. In some examples, aspects of the operations of 1405 may be performed by a time period transmission component 825 as described with reference to FIG. 8.

At 1410, the method may include pausing a connected mode inactivity timer, a connected mode idle timer, or both, at the first wireless device at a beginning of the time period. The operations of 1410 may be performed in accordance with examples as disclosed herein. In some examples, aspects of the operations of 1410 may be performed by a timer component 830 as described with reference to FIG. 8.

At 1415, the method may include performing the energy harvesting procedure during the time period. The operations of 1415 may be performed in accordance with examples as disclosed herein. In some examples, aspects of the operations of 1415 may be performed by an energy harvesting component 835 as described with reference to FIG. 8.

At 1420, the method may include resuming the connected mode inactivity timer, the connected mode idle timer, or both, at an end of the time period. The operations of 1420 may be performed in accordance with examples as disclosed herein. In some examples, aspects of the operations of 1420 may be performed by a timer component 830 as described with reference to FIG. 8.

At 1425, the method may include communicating with the second wireless device in a connected communications mode after the end of the time period and in accordance with a status of the connected mode inactivity timer, the connected mode idle timer, or both. The operations of 1425 may be performed in accordance with examples as disclosed herein. In some examples, aspects of the operations of 1425 may be performed by a connected communications component 840 as described with reference to FIG. 8.

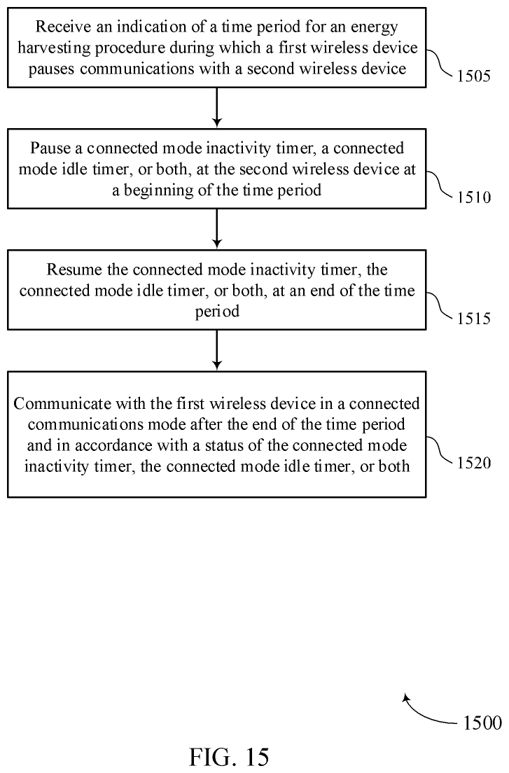

FIG. 15 shows a flowchart illustrating a method 1500 that supports energy harvesting activity timeouts in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include receiving an indication of a time period for an energy harvesting procedure during which a first wireless device pauses communications with a second wireless device. The operations of 1505 may be performed in accordance with examples as disclosed herein. In some examples, aspects of the operations of 1505 may be performed by a time period reception component 1225 as described with reference to FIG. 12.

At 1510, the method may include pausing a connected mode inactivity timer, a connected mode idle timer, or both, at the second wireless device at a beginning of the time period. The operations of 1510 may be performed in accordance with examples as disclosed herein. In some examples, aspects of the operations of 1510 may be performed by a timer component 1230 as described with reference to FIG. 12.

At 1515, the method may include resuming the connected mode inactivity timer, the connected mode idle timer, or both, at an end of the time period. The operations of 1515 may be performed in accordance with examples as disclosed herein. In some examples, aspects of the operations of 1515 may be performed by a timer component 1230 as described with reference to FIG. 12.

At 1520, the method may include communicating with the first wireless device in a connected communications mode after the end of the time period and in accordance with a status of the connected mode inactivity timer, the connected mode idle timer, or both. The operations of 1520 may be performed in accordance with examples as disclosed herein. In some examples, aspects of the operations of 1520 may be performed by a connected communications component 1235 as described with reference to FIG. 12.

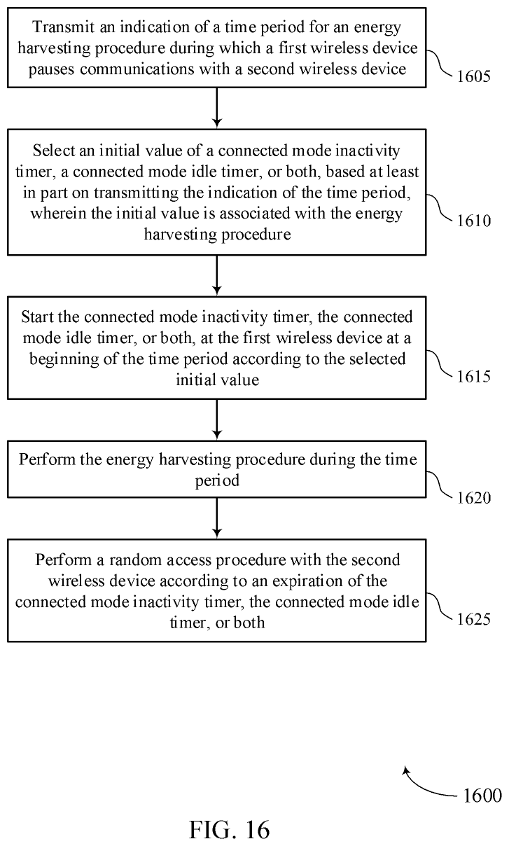

FIG. 16 shows a flowchart illustrating a method 1600 that supports energy harvesting activity timeouts in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting an indication of a time period for an energy harvesting procedure during which a first wireless device pauses communications with a second wireless device. The operations of 1605 may be performed in accordance with examples as disclosed herein. In some examples, aspects of the operations of 1605 may be performed by a time period transmission component 825 as described with reference to FIG. 8.

At 1610, the method may include selecting an initial value of a connected mode inactivity timer, a connected mode idle timer, or both, based on transmitting the indication of the time period, where the initial value is associated with the energy harvesting procedure. The operations of 1610 may be performed in accordance with examples as disclosed herein. In some examples, aspects of the operations of 1610 may be performed by a timer component 830 as described with reference to FIG. 8.

At 1615, the method may include starting the connected mode inactivity timer, the connected mode idle timer, or both, at the first wireless device at a beginning of the time period according to the selected initial value. The operations of 1615 may be performed in accordance with examples as disclosed herein. In some examples, aspects of the operations of 1615 may be performed by a timer component 830 as described with reference to FIG. 8.

At 1620, the method may include performing the energy harvesting procedure during the time period. The operations of 1620 may be performed in accordance with examples as disclosed herein. In some examples, aspects of the operations of 1620 may be performed by an energy harvesting component 835 as described with reference to FIG. 8.

At 1625, the method may include performing a random access procedure with the second wireless device according to an expiration of the connected mode inactivity timer, the connected mode idle timer, or both. The operations of 1625 may be performed in accordance with examples as disclosed herein. In some examples, aspects of the operations of 1625 may be performed by a random access procedure component 845 as described with reference to FIG. 8.

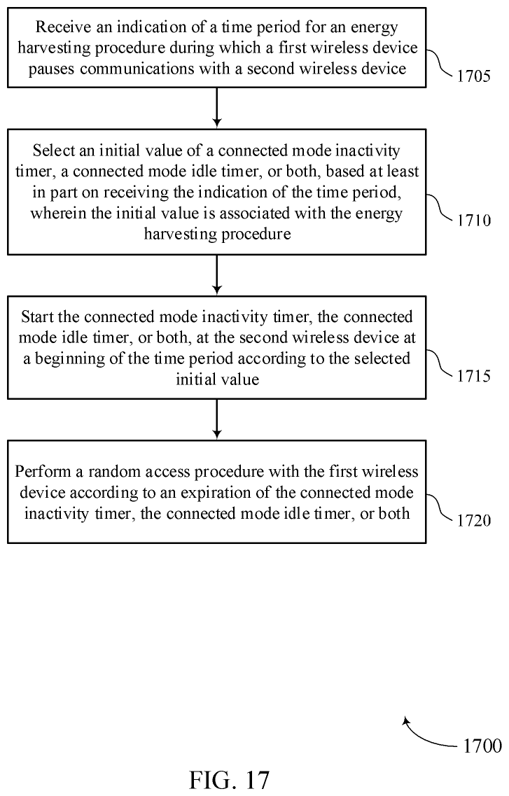

FIG. 17 shows a flowchart illustrating a method 1700 that supports energy harvesting activity timeouts in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving an indication of a time period for an energy harvesting procedure during which a first wireless device pauses communications with a second wireless device. The operations of 1705 may be performed in accordance with examples as disclosed herein. In some examples, aspects of the operations of 1705 may be performed by a time period reception component 1225 as described with reference to FIG. 12.

At 1710, the method may include selecting an initial value of a connected mode inactivity timer, a connected mode idle timer, or both, based on receiving the indication of the time period, where the initial value is associated with the energy harvesting procedure. The operations of 1710 may be performed in accordance with examples as disclosed herein. In some examples, aspects of the operations of 1710 may be performed by a timer component 1230 as described with reference to FIG. 12.

At 1715, the method may include starting the connected mode inactivity timer, the connected mode idle timer, or both, at the second wireless device at a beginning of the time period according to the selected initial value. The operations of 1715 may be performed in accordance with examples as disclosed herein. In some examples, aspects of the operations of 1715 may be performed by a timer component 1230 as described with reference to FIG. 12.

At 1720, the method may include performing a random access procedure with the first wireless device according to an expiration of the connected mode inactivity timer, the connected mode idle timer, or both. The operations of 1720 may be performed in accordance with examples as disclosed herein. In some examples, aspects of the operations of 1720 may be performed by a random access procedure component 1240 as described with reference to FIG. 12.

The following provides an overview of aspects of the present disclosure:
Aspect 1: A method for wireless communications, comprising: transmitting an indication of a time period for an energy harvesting procedure during which a first wireless device pauses communications with a second wireless device; pausing a connected mode inactivity timer, a connected mode idle timer, or both, at the first wireless device at a beginning of the time period; performing the energy harvesting procedure during the time period; resuming the connected mode inactivity timer, the connected mode idle timer, or both, at an end of the time period; and communicating with the second wireless device in a connected communications mode after the end of the time period and in accordance with a status of the connected mode inactivity timer, the connected mode idle timer, or both.
Aspect 2: The method of aspect 1, further comprising: receiving control signaling indicating that the first wireless device is to communicate with the second wireless device during a second time period.
Aspect 3: The method of any of aspects 1 through 2, further comprising: receiving control signaling indicating that the first wireless device is to perform a random access procedure over a set of random access resources indicated in the control signaling.
Aspect 4: The method of aspect 3, further comprising: performing the random access procedure over the set of random access resources with the second wireless device in accordance with the received control signaling.
Aspect 5: The method of any of aspects 3 through 4, further comprising: transmitting a random access preamble and an indication that the first wireless device will pause random access procedure communications.
Aspect 6: The method of any of aspects 3 through 5, further comprising: transmitting the indication of the time period comprising an indication that the first wireless device will not perform the random access procedure.
Aspect 7: The method of any of aspects 1 through 6, further comprising: transmitting an indication that the first wireless device has resumed the connected mode inactivity timer, the connected mode idle timer, or both, based at least in part on resuming the connected mode inactivity timer, the connected mode idle timer, or both.
Aspect 8: The method of aspect 7, further comprising: starting a resumed communications timer; and performing a random access procedure with the second wireless device according to an expiration of the resumed communications timer.
Aspect 9: A method for wireless communications, comprising: receiving an indication of a time period for an energy harvesting procedure during which a first wireless device pauses communications with a second wireless device; pausing a connected mode inactivity timer, a connected mode idle timer, or both, at the second wireless device at a beginning of the time period; resuming the connected mode inactivity timer, the connected mode idle timer, or both, at an end of the time period; and communicating with the first wireless device in a connected communications mode after the end of the time period and in accordance with a status of the connected mode inactivity timer, the connected mode idle timer, or both.
Aspect 10: The method of aspect 9, further comprising: transmitting control signaling indicating that the first wireless device is to communicate with the second wireless device during a second time period.
Aspect 11: The method of any of aspects 9 through 10, further comprising: transmitting control signaling indicating that the first wireless device is to perform a random access procedure over a set of random access resources indicated in the control signaling.
Aspect 12: The method of aspect 11, further comprising: performing the random access procedure over the set of random access resources with the first wireless device in accordance with the transmitted control signaling.
Aspect 13: The method of any of aspects 11 through 12, further comprising: receiving a random access preamble and an indication that the first wireless device will pause random access procedure communications.
Aspect 14: The method of any of aspects 11 through 13, further comprising: receiving the indication of the time period comprising an indication that the first wireless device will not perform the random access procedure.
Aspect 15: The method of any of aspects 9 through 14, further comprising: receiving an indication that the first wireless device has resumed the connected mode inactivity timer, the connected mode idle timer, or both, based at least in part on resuming the connected mode inactivity timer, the connected mode idle timer, or both.
Aspect 16: The method of aspect 15, further comprising: starting a resumed communications timer; and performing a random access procedure with the first wireless device according to an expiration of the resumed communications timer.
Aspect 17: A method for wireless communication, comprising: transmitting an indication of a time period for an energy harvesting procedure during which a first wireless device pauses communications with a second wireless device; selecting an initial value of a connected mode inactivity timer, a connected mode idle timer, or both, based at least in part on transmitting the indication of the time period, wherein the initial value is associated with the energy harvesting procedure; starting the connected mode inactivity timer, the connected mode idle timer, or both, at the first wireless device at a beginning of the time period according to the selected initial value; performing the energy harvesting procedure during the time period; and performing a random access procedure with the second wireless device according to an expiration of the connected mode inactivity timer, the connected mode idle timer, or both.
Aspect 18: The method of aspect 17, further comprising: determining that the first wireless device will enter an idle mode based at least in part on a length of the time period being greater than the initial value of the connected mode inactivity timer, the connected mode idle timer, or both.
Aspect 19: The method of any of aspects 17 through 18, further comprising: receiving an indication of random access resources; and performing the random access procedure over the indicated random access resources.
Aspect 20: The method of aspect 19, further comprising: receiving control signaling comprising an indication of a time delay after an end of the time period for the energy harvesting procedure after which the random access procedure is to be performed, an indication of the initial value of the connected mode inactivity timer, the connected mode idle timer, or both, or any combination thereof.
Aspect 21: The method of any of aspects 17 through 20, further comprising: transmitting an updated indication of the time period for the energy harvesting procedure.
Aspect 22: The method of aspect 21, further comprising: receiving control signaling comprising an indication of a timing advance associated with performing the random access procedure based at least in part on a length of the updated indication of the time period being longer than a threshold length.
Aspect 23: The method of aspect 22, further comprising: performing the random access procedure based at least in part on the received indication of the timing advance.
Aspect 24: A method for wireless communication, comprising: receiving an indication of a time period for an energy harvesting procedure during which a first wireless device pauses communications with a second wireless device; selecting an initial value of a connected mode inactivity timer, a connected mode idle timer, or both, based at least in part on receiving the indication of the time period, wherein the initial value is associated with the energy harvesting procedure; starting the connected mode inactivity timer, the connected mode idle timer, or both, at the second wireless device at a beginning of the time period according to the selected initial value; and performing a random access procedure with the first wireless device according to an expiration of the connected mode inactivity timer, the connected mode idle timer, or both.
Aspect 25: The method of aspect 24, further comprising: determining that the first wireless device will enter an idle mode based at least in part on a length of the time period being greater than the initial value of the connected mode inactivity timer, the connected mode idle timer, or both.
Aspect 26: The method of any of aspects 24 through 25, further comprising: transmitting an indication of random access resources; and performing the random access procedure over the indicated random access resources.
Aspect 27: The method of aspect 26, further comprising: transmitting control signaling comprising an indication of a time delay after an end of the time period for the energy harvesting procedure after which the random access procedure is to be performed, an indication of the initial value of the connected mode inactivity timer, the connected mode idle timer, or both, or any combination thereof.
Aspect 28: The method of any of aspects 24 through 27, further comprising: receiving an updated indication of the time period for the energy harvesting procedure.
Aspect 29: The method of aspect 28, further comprising: transmitting control signaling comprising an indication of a timing advance associated with performing the random access procedure based at least in part on a length of the updated indication of the time period being longer than a threshold length.
Aspect 30: The method of aspect 29, further comprising: performing the random access procedure based at least in part on the transmitted indication of the timing advance.
Aspect 31: An apparatus for wireless communications, comprising a processor; memory coupled with the processor; and instructions stored in the memory and executable by the processor to cause the apparatus to perform a method of any of aspects 1 through 8.
Aspect 32: An apparatus for wireless communications, comprising at least one means for performing a method of any of aspects 1 through 8.
Aspect 33: A non-transitory computer-readable medium storing code for wireless communications, the code comprising instructions executable by a processor to perform a method of any of aspects 1 through 8.
Aspect 34: An apparatus for wireless communications, comprising a processor; memory coupled with the processor; and instructions stored in the memory and executable by the processor to cause the apparatus to perform a method of any of aspects 9 through 16.
Aspect 35: An apparatus for wireless communications, comprising at least one means for performing a method of any of aspects 9 through 16.
Aspect 36: A non-transitory computer-readable medium storing code for wireless communications, the code comprising instructions executable by a processor to perform a method of any of aspects 9 through 16.
Aspect 37: An apparatus for wireless communication, comprising a processor; memory coupled with the processor; and instructions stored in the memory and executable by the processor to cause the apparatus to perform a method of any of aspects 17 through 23.
Aspect 38: An apparatus for wireless communication, comprising at least one means for performing a method of any of aspects 17 through 23.
Aspect 39: A non-transitory computer-readable medium storing code for wireless communication, the code comprising instructions executable by a processor to perform a method of any of aspects 17 through 23.
Aspect 40: An apparatus for wireless communication, comprising a processor; memory coupled with the processor; and instructions stored in the memory and executable by the processor to cause the apparatus to perform a method of any of aspects 24 through 30.
Aspect 41: An apparatus for wireless communication, comprising at least one means for performing a method of any of aspects 24 through 30.
Aspect 42: A non-transitory computer-readable medium storing code for wireless communication, the code comprising instructions executable by a processor to perform a method of any of aspects 24 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
at least one processor; and
memory coupled to the at least one processor, the memory storing instructions executable by the at least one processor to cause the apparatus to:
transmit an indication of a time period for an energy harvesting procedure during which a first wireless device pauses communications with a second wireless device;
pause a connected mode inactivity timer, a connected mode idle timer, or both, at the first wireless device at a beginning of the time period;
perform the energy harvesting procedure during the time period;
resume the connected mode inactivity timer, the connected mode idle timer, or both, at an end of the time period; and
communicate with the second wireless device in a connected communications mode after the end of the time period and in accordance with a status of the connected mode inactivity timer, the connected mode idle timer, or both.

2. The apparatus of claim 1, wherein the instructions are further executable by the at least one processor to cause the apparatus to:
receive control signaling indicating that the first wireless device is to communicate with the second wireless device during a second time period.

3. The apparatus of claim 1, wherein the instructions are further executable by the at least one processor to cause the apparatus to:
receive control signaling indicating that the first wireless device is to perform a random access procedure over a set of random access resources indicated in the control signaling.

4. The apparatus of claim 3, wherein the instructions are further executable by the at least one processor to cause the apparatus to:
perform the random access procedure over the set of random access resources with the second wireless device in accordance with the received control signaling.

5. The apparatus of claim 3, wherein the instructions are further executable by the at least one processor to cause the apparatus to:
transmit a random access preamble and an indication that the first wireless device will pause random access procedure communications.

6. The apparatus of claim 3, wherein the instructions are further executable by the at least one processor to cause the apparatus to:
transmit the indication of the time period comprising an indication that the first wireless device will not perform the random access procedure.

7. The apparatus of claim 1, wherein the instructions are further executable by the at least one processor to cause the apparatus to:
transmit an indication that the first wireless device has resumed the connected mode inactivity timer, the connected mode idle timer, or both, based at least in part on resuming the connected mode inactivity timer, the connected mode idle timer, or both.

8. The apparatus of claim 7, wherein the instructions are further executable by the at least one processor to cause the apparatus to:
start a resumed communications timer; and
perform a random access procedure with the second wireless device according to an expiration of the resumed communications timer.

9. An apparatus for wireless communications, comprising:
at least one processor; and
memory coupled to the at least one processor, the memory storing instructions executable by the at least one processor to cause the apparatus to:
receive an indication of a time period for an energy harvesting procedure during which a first wireless device pauses communications with a second wireless device;
pause a connected mode inactivity timer, a connected mode idle timer, or both, at the second wireless device at a beginning of the time period;
resume the connected mode inactivity timer, the connected mode idle timer, or both, at an end of the time period; and
communicate with the first wireless device in a connected communications mode after the end of the time period and in accordance with a status of the connected mode inactivity timer, the connected mode idle timer, or both.

10. The apparatus of claim 9, wherein the instructions are further executable by the at least one processor to cause the apparatus to:
transmit control signaling indicating that the first wireless device is to communicate with the second wireless device during a second time period.

11. The apparatus of claim 9, wherein the instructions are further executable by the at least one processor to cause the apparatus to:
transmit control signaling indicating that the first wireless device is to perform a random access procedure over a set of random access resources indicated in the control signaling.

12. The apparatus of claim 11, wherein the instructions are further executable by the at least one processor to cause the apparatus to:
perform the random access procedure over the set of random access resources with the first wireless device in accordance with the transmitted control signaling.

13. The apparatus of claim 11, wherein the instructions are further executable by the at least one processor to cause the apparatus to:
receive a random access preamble and an indication that the first wireless device will pause random access procedure communications.

14. The apparatus of claim 11, wherein the instructions are further executable by the at least one processor to cause the apparatus to:
receive the indication of the time period comprising an indication that the first wireless device will not perform the random access procedure.

15. The apparatus of claim 9, wherein the instructions are further executable by the at least one processor to cause the apparatus to:
receive an indication that the first wireless device has resumed the connected mode inactivity timer, the connected mode idle timer, or both, based at least in part on resuming the connected mode inactivity timer, the connected mode idle timer, or both.

16. The apparatus of claim 15, wherein the instructions are further executable by the at least one processor to cause the apparatus to:
start a resumed communications timer; and
perform a random access procedure with the first wireless device according to an expiration of the resumed communications timer.

17. An apparatus for wireless communication, comprising:
at least one processor; and
memory coupled to the at least one processor, the memory storing instructions executable by the at least one processor to cause the apparatus to:
transmit an indication of a time period for an energy harvesting procedure during which a first wireless device pauses communications with a second wireless device;
select an initial value of a connected mode inactivity timer, a connected mode idle timer, or both, based at least in part on transmitting the indication of the time period, wherein the initial value is associated with the energy harvesting procedure;
start the connected mode inactivity timer, the connected mode idle timer, or both, at the first wireless device at a beginning of the time period according to the selected initial value;
perform the energy harvesting procedure during the time period; and
perform a random access procedure with the second wireless device according to an expiration of the connected mode inactivity timer, the connected mode idle timer, or both.

18. The apparatus of claim 17, wherein the instructions are further executable by the at least one processor to cause the apparatus to:
determine that the first wireless device will enter an idle mode based at least in part on a length of the time period being greater than the initial value of the connected mode inactivity timer, the connected mode idle timer, or both.

19. The apparatus of claim 17, wherein the instructions are further executable by the at least one processor to cause the apparatus to:
receive an indication of random access resources; and
perform the random access procedure over the indicated random access resources.

20. The apparatus of claim 19, wherein the instructions are further executable by the at least one processor to cause the apparatus to:
receive control signaling comprising an indication of a time delay after an end of the time period for the energy harvesting procedure after which the random access procedure is to be performed, an indication of the initial value of the connected mode inactivity timer, the connected mode idle timer, or both, or any combination thereof.

21. The apparatus of claim 17, wherein the instructions are further executable by the at least one processor to cause the apparatus to:
transmit an updated indication of the time period for the energy harvesting procedure.

22. The apparatus of claim 21, wherein the instructions are further executable by the at least one processor to cause the apparatus to:
receive control signaling comprising an indication of a timing advance associated with performing the random access procedure based at least in part on a length of the updated indication of the time period being longer than a threshold length.

23. The apparatus of claim 22, wherein the instructions are further executable by the at least one processor to cause the apparatus to:
perform the random access procedure based at least in part on the received indication of the timing advance.

24. An apparatus for wireless communication, comprising:
at least one processor; and
memory coupled to the at least one processor, the memory storing instructions executable by the at least one processor to cause the apparatus to:
receive an indication of a time period for an energy harvesting procedure during which a first wireless device pauses communications with a second wireless device;
select an initial value of a connected mode inactivity timer, a connected mode idle timer, or both, based at least in part on receiving the indication of the time period, wherein the initial value is associated with the energy harvesting procedure;
start the connected mode inactivity timer, the connected mode idle timer, or both, at the second wireless device at a beginning of the time period according to the selected initial value; and
perform a random access procedure with the first wireless device according to an expiration of the connected mode inactivity timer, the connected mode idle timer, or both.

25. The apparatus of claim 24, wherein the instructions are further executable by the at least one processor to cause the apparatus to:
determine that the first wireless device will enter an idle mode based at least in part on a length of the time period being greater than the initial value of the connected mode inactivity timer, the connected mode idle timer, or both.

26. The apparatus of claim 24, wherein the instructions are further executable by the at least one processor to cause the apparatus to:
transmit an indication of random access resources; and
perform the random access procedure over the indicated random access resources.

27. The apparatus of claim 26, wherein the instructions are further executable by the at least one processor to cause the apparatus to:
transmit control signaling comprising an indication of a time delay after an end of the time period for the energy harvesting procedure after which the random access procedure is to be performed, an indication of the initial value of the connected mode inactivity timer, the connected mode idle timer, or both, or any combination thereof.

28. The apparatus of claim 24, wherein the instructions are further executable by the at least one processor to cause the apparatus to:
receive an updated indication of the time period for the energy harvesting procedure.

29. The apparatus of claim 28, wherein the instructions are further executable by the at least one processor to cause the apparatus to:
transmit control signaling comprising an indication of a timing advance associated with performing the random access procedure based at least in part on a length of the updated indication of the time period being longer than a threshold length.

30. The apparatus of claim 29, wherein the instructions are further executable by the at least one processor to cause the apparatus to:
perform the random access procedure based at least in part on the transmitted indication of the timing advance.
